(19) United States
(12) Patent Application Publication
(10) Pub. No.: US 2015/0241951 A1
(43) Pub. Date: Aug. 27, 2015

(54) DATA PROCESSING METHOD, DRAWING DEVICE, AND STORAGE MEDIUM

(71) Applicant: FUJITSU LIMITED, Kawasaki-shi (JP)

(72) Inventors: Masaaki NORO, Kawasaki (JP); Takeo Murakami, Kawasaki (JP)

(73) Assignee: FUJITSU LIMITED, Kawasaki-shi (JP)

(21) Appl. No.: 14/591,096

(22) Filed: Jan. 7, 2015

(30) Foreign Application Priority Data
Feb. 21, 2014 (JP) 2014-032317

(51) Int. Cl. G06F 1/32; G09G 5/00; G06T 1/20

(52) U.S. Cl. CPC G06F 1/3265; G06T 1/20; G09G 5/006; G09G 2330/021

(57) ABSTRACT

A data processing method for updating a picture to be displayed in a display, based on a synchronization signal issued in each predetermined time period, the data processing method including calculating a scheduled number of sub-pictures scheduled to be created by a processor in a first time period from issuing of a first synchronization signal until the predetermined time period elapses, the sub-pictures being pieces of pictures included in the picture to be displayed in the display, counting an actual number of sub-pictures created by the processor in the first time period, detecting that the actual number of sub-pictures reaches the scheduled number of sub-pictures; and reducing power consumption of the processor, based on the detecting that the actual number of sub-pictures reaches the scheduled number of sub-pictures.

### CROSS-REFERENCE TO RELATED APPLICATION

This application is based upon and claims the benefit of priority of the prior Japanese Patent Application No. 2014-032317, filed on Feb. 21, 2014, the entire contents of which are incorporated herein by reference.

### FIELD

The embodiments discussed herein are related to a data processing method, a drawing device, and a storage medium.

### BACKGROUND

In mobile terminals such as notebook computers and smartphones, there has been developed a technology for suppressing power consumption so as to maintain being powered by batteries. As one of types of electric power consumed in a mobile terminal, the power consumption of a processor that creates the data of sub-pictures to be displayed in a display is included. In a case where, for example, application software (hereinafter, referred to as an application) activated on a smartphone updates a sub-picture on the display, a processor included in the smartphone performs creation processing for new sub-picture data and displays a new sub-picture, based on the created sub-picture data. The update of the sub-picture is performed in synchronization with a synchronization signal such as a vertical synchronization signal issued at predetermined time intervals.

As a technology for suppressing the power consumption of the processor that creates the sub-picture data to be updated in synchronization with the synchronization signal, there is a technology for switching the operation mode of the processor to a low power consumption mode when creation processing for the sub-picture data, which is to be executed, is completed before issuing of a subsequent synchronization signal. Japanese Laid-open Patent Publication No. 2005-62798 discusses such a technology.

### SUMMARY

According to an aspect of the invention, a data processing method for updating a picture to be displayed in a display, based on a synchronization signal issued in each predetermined time period, the data processing method including calculating a scheduled number of sub-pictures scheduled to be created by a processor in a first time period from issuing of a first synchronization signal until the predetermined time period elapses, the sub-pictures being pieces of pictures included in the picture to be displayed in the display, counting an actual number of sub-pictures created by the processor in the first time period, detecting that the actual number of sub-pictures reaches the scheduled number of sub-pictures; and reducing power consumption of the processor, based on the detecting that the actual number of sub-pictures reaches the scheduled number of sub-pictures.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram explaining definitions of terms used in a first embodiment;

FIG. 2 is a hardware configuration diagram of a display device in the first embodiment;

FIG. 3 is a diagram illustrating a relationship between operation modes of a graphics data processing unit, electric power consumed in the graphics data processing unit, and so forth in the first embodiment;

FIG. 4 is a diagram illustrating a processing procedure relating to picture creation and display performed by a display device in the first embodiment;

FIG. 5 is a diagram illustrating the operation modes illustrated in FIG. 3 while associating the operation modes with processing illustrated in FIG. 4;

FIG. 6 is a functional block diagram of a CPU in the first embodiment;

FIG. 7 is a functional block diagram of a sub-picture creation start notification unit in the first embodiment;

FIG. 8 is an example of a distribution destination registration table in the first embodiment;

FIG. 9 is a diagram explaining a processing timing when a plurality of applications receive sub-picture creation start notices in the first embodiment;

FIG. 10 is a diagram illustrating details of a sub-picture creation processing operation based on each application in the first embodiment;

FIG. 11 is a functional block diagram of a sub-picture creation termination notification unit in the first embodiment;

FIG. 12 is a functional block diagram of a completion detection unit in the first embodiment;

FIG. 13 is a functional block diagram of a mode management unit in the first embodiment;

FIG. 14 is a flowchart of processing performed by the sub-picture creation start notification unit in the first embodiment;

FIG. 15 is a flowchart of processing performed by the sub-picture creation termination notification unit in the first embodiment;

FIG. 16 is a flowchart of processing performed by the completion detection unit in the first embodiment;

FIG. 17 is a flowchart of processing performed by the mode management unit in the first embodiment;

FIG. 18 is a diagram illustrating states in a case where the operation mode of the graphics data processing unit is put into a suspended mode when data processing is terminated in the first embodiment;

FIG. 19 is a diagram explaining definitions of terms used in a second embodiment;

FIG. 20 is a diagram explaining the total number of sub-picture creation processing operations in a case where one application performs two or more sub-picture creation processing operations;

FIG. 21 is a functional block diagram of a CPU in the second embodiment;

FIG. 22 is a functional block diagram of a redistribution processing unit in the second embodiment;

FIG. 23 illustrates an example of a redistribution destination registration table in the second embodiment;

FIG. 24 is a flowchart of processing performed by the redistribution processing unit in the second embodiment;

FIG. 25 is a flowchart of processing performed by a completion detection unit in the second embodiment;

FIG. 26 is a functional block diagram of a CPU in an example of a modification to the second embodiment;

FIG. 27 is a functional block diagram of a notice transfer unit in the example of a modification to the second embodiment;

FIG. 28 is a flowchart of processing performed by the notice transfer unit in the example of a modification to the second embodiment;

FIG. 29 is a functional block diagram of a CPU in a third embodiment;

FIG. 30 is a functional block diagram of a completion detection unit in the third embodiment;

FIG. 31 is a flowchart of processing performed by a codec conversion processing unit in the third embodiment; and

FIG. 32 is a flowchart of processing performed by the completion detection unit in the third embodiment.

### DESCRIPTION OF EMBODIMENTS

The above-mentioned Japanese Laid-open Patent Publication No. 2005-62798 describes that the processor is shifted to the low power consumption mode in a case where, before termination of a unit time period, processing of sub-picture data to be processed within the time period is completed. However, Japanese Laid-open Patent Publication No. 2005-62798 does not disclose a specific method for recognizing that the whole processing of sub-picture data to be processed is completed. Therefore, in the method disclosed in Japanese Laid-open Patent Publication No. 2005-62798, there is not sufficient convenience as a technology for suppressing power consumption.

The embodiments discussed herein provide a technology for detecting that processing of sub-picture data to be executed in a unit time period is completed and suppressing power consumption of a processor.

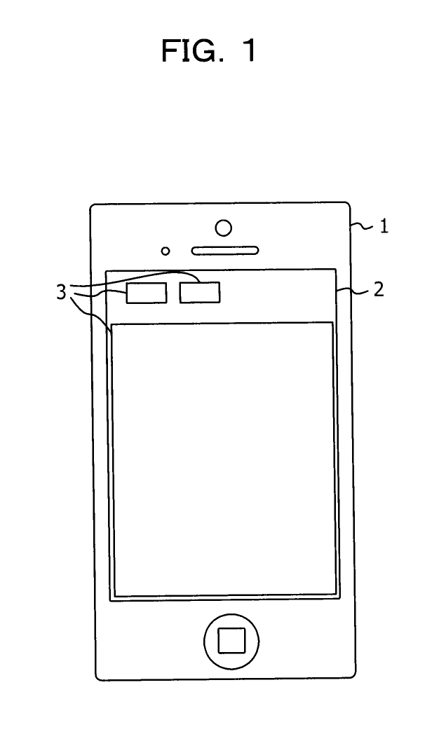

FIG. 1 is a diagram explaining definitions of terms used in a first embodiment. FIG. 1 exemplifies a mobile terminal such as a smartphone, as a display device 1. An image displayed in a whole display 2 is called a “picture”. One “picture” is continuously displayed in the display 2, and in a case where a synchronization signal is issued 60 times per second, 60 “pictures” per second are sequentially updated on the display. In this regard, however, in a state of a still image, the “picture” is not updated, and a same “picture” is displayed during a given period of time. One “picture” includes images 3 individually drawn by applications. The images 3 drawn by the respective applications are individually “sub-pictures”. In the example illustrated in FIG. 1, three applications each display a “sub-picture” within the “picture”.

In the present embodiment, a specific method will be disclosed, the specific method being used for detecting that data processing relating to picture creation to be processed within a time period (hereinafter, referred to as a unit time period) from a synchronization signal (hereinafter, referred to as Vsync) to a subsequently issued synchronization signal is completed. By detecting that the data processing relating to picture creation is completed, it is possible to adequately recognize a time period in which the processor is able to be suspended, and it is possible to suppress the power consumption of the display device 1.

Even a case where processing for creating data of one sub-picture is terminated within the unit time period is far from a case where whole data processing relating to picture creation is completed. The reason is that, as in a case where a plurality of applications each update a sub-picture, there is a case where creation of a plurality of pieces of sub-picture data is performed within the same unit time period. In addition, the number of applications that each performs sub-picture creation within the unit time period may vary in each unit time period. In such a state, the present embodiment discloses a method for detecting that the whole sub-picture creation to be executed within the unit time period is terminated and suppressing the power consumption of the display device 1. Specifically, the scheduled number of sub-pictures scheduled to be created in each unit time period is understood, the actual number of actually created sub-pictures is counted, and that the whole sub-picture creation processing is terminated is detected based on it that the actual number of sub-pictures reaches the scheduled number of sub-pictures. An understanding method for the scheduled number of sub-pictures, a counting method for the actual number of sub-pictures, and so forth will be described based on drawings.

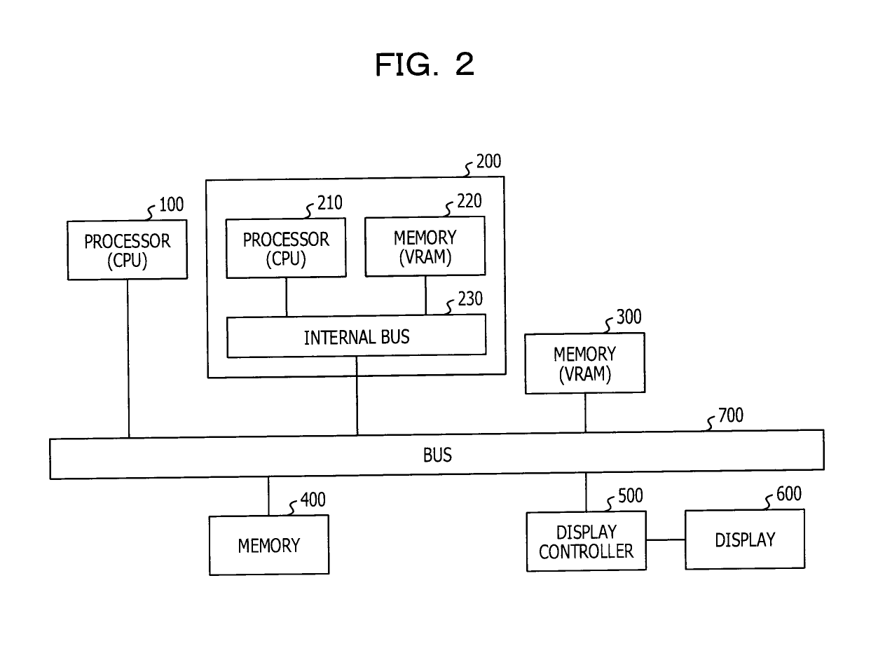

FIG. 2 is the hardware configuration diagram of the display device 1 in the first embodiment. The display device 1 is a mobile terminal such as, for example, a notebook computer, a tablet computer, or a smartphone. The display device 1 includes a bus 700, an internal bus 230, a processor 100, a processor 210, a memory 220, a memory 300, a memory 400, a display controller 500, and a display 600. The processor 210 and the memory 220 are connected to the bus 700 through the internal bus 230. The processor 100 performs management of the whole display device 1 and data processing. The memory 400 is used as the main memory of the display device 1. The processor 210 is a processor that mainly performs data processing relating to creation of sub-pictures and pictures, and is called a graphic processing unit (GPU). The memory 220 is a memory mainly storing therein sub-picture data and picture data, and is called a video random access memory (VRAM). In addition, the memory 300 is a VRAM mainly storing therein picture data. The display controller 500 displays a created picture on the display 600.

Each of the processors 100 and 210 is an electronic circuit component such as a central processing unit (CPU), a micro-processing unit (MPU), a digital signal processor (DSP), or a field-programmable gate array (FPGA). Each of the memories 220, 300, and 400 is an electronic circuit component such as a dynamic random access memory (DRAM) or a static random access memory (SRAM). In the following part of the present specification, for the sake of convenience, it is assumed that the processor 100 is called a CPU, and the processor 210 is called a GPU. In addition, for the sake of convenience, it is assumed that the memory 220 is called a first VRAM and the memory 300 is called a second VRAM.

The CPU 100, the GPU 210, the first VRAM 220, and the internal bus 230 illustrated in FIG. 2 may be formed as a single semiconductor chip serving as a system on chip (SoC). In addition, for the sake of convenience, it is assumed that the GPU 210, the first VRAM 220, and the internal bus 230 are collectively called a graphics data processing unit 200 in the present specification.

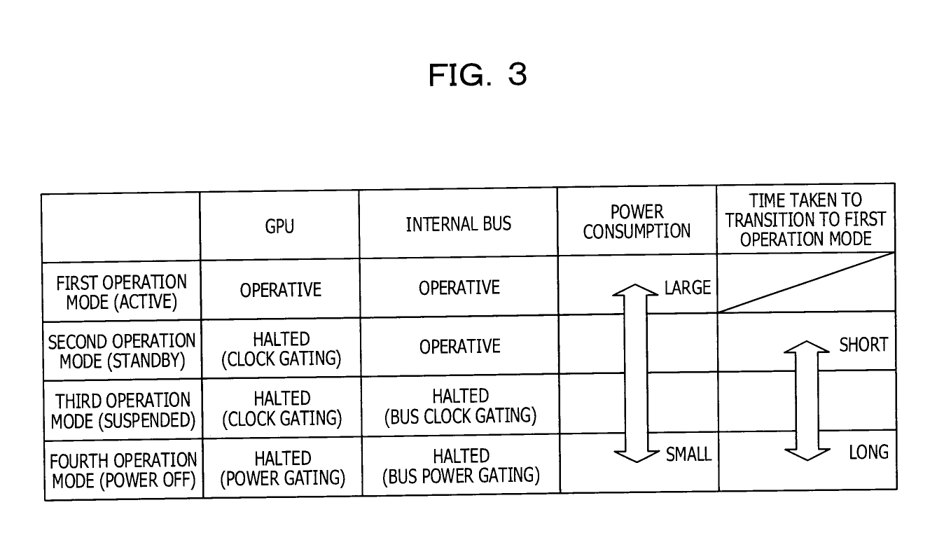

FIG. 3 is a diagram illustrating a relationship between the operation modes of the graphics data processing unit 200, electric power consumed in the graphics data processing unit 200, and so forth. In the present embodiment, as the operation modes, four modes are illustrated. A first operation mode is a mode in which both the GPU 210 and the internal bus 230 operate. In the present specification, the first operation mode is called an active mode. A second operation mode is a state in which a clock supplied to the GPU 210 is halted. In this state, the GPU 210 does not perform data processing. In the present specification, the second operation mode is called a standby mode. Note that the meaning of halting of a clock includes both of halting of a clock generation circuit serving as a clock supply source and so-called clock gating in which a clock supply path is disconnected while the clock generation circuit remains caused to operate. A third operation mode is a state in which the clock supplied to the GPU 210 is halted and a clock supplied to the internal bus 230 is halted. In this state, the GPU 210 does not perform data processing, and is in a state of being difficult to access the first VRAM 220. In the present specification, the third operation mode is called a suspended mode. A fourth operation mode is a state in which power supply to the GPU 210 is halted and power supply to the internal bus 230 is halted. In the present specification, the fourth operation mode is called a power-off mode. Note that the meaning of halting of power supply includes both of halting of a power supply circuit serving as a supply source of electric power and so-called power gating in which a power supply path is disconnected while the power supply circuit remains caused to operate.

As illustrated in FIG. 3, electric power consumed in the graphics data processing unit 200 in the first operation mode is the largest, and electric power consumed in the graphics data processing unit 200 in the fourth mode is the smallest. In addition, time taken to transition from the second operation mode to the first operation mode is the shortest, and time taken to transition from the fourth operation mode to the first operation mode is the longest. Note that the four operation modes illustrated in FIG. 3 are exemplifications for explaining a plurality of operation modes whose power consumption amounts are different, and the display device 1 are not intended to include the operation modes disclosed here, as an indispensable condition. Note that the nominal designations of the individual operation modes are not intended to limit the embodiment, and other nominal designations may be assigned.

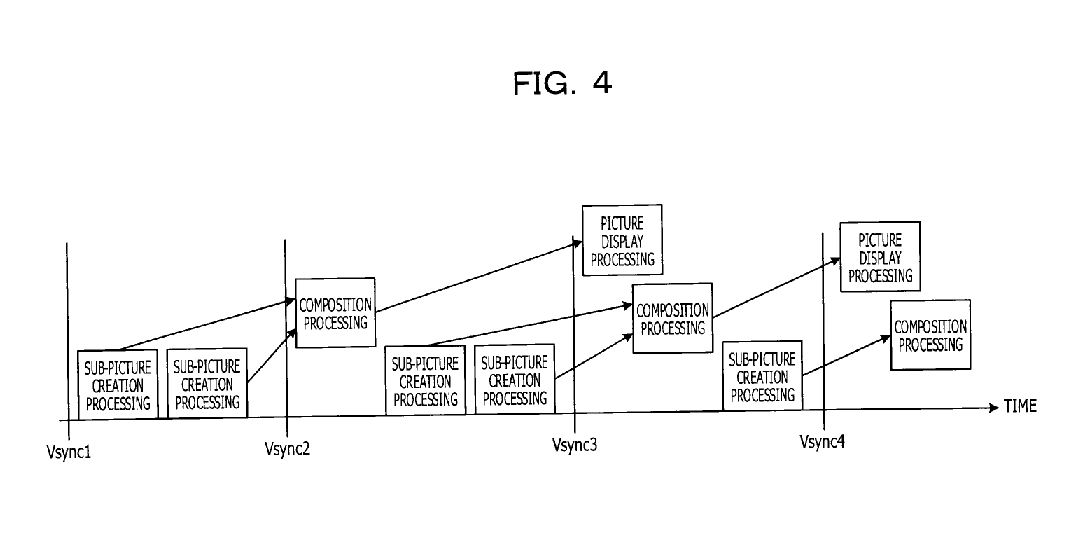

A processing procedure relating to picture creation and display performed in the display device 1 will be described based on FIG. 4. The display device 1 creates and displays a picture of one frame in the display 600, in synchronization with Vsync issued at predetermined intervals. In FIG. 4, a horizontal axis is a temporal axis, and the flow of processing relating to picture creation and display executed with respect to each Vsync issued sequentially is illustrated. Note that, in the present specification, the term “sub-picture creation” means processing for creating sub-picture data, a term “composition processing” means processing for composing pieces of sub-picture data and creating picture data to be finally displayed in the display 600, and the term “display” means actually displaying the picture data in the display 600.

In FIG. 4, first, based on issuing of Vsync1, a sub-picture creation processing operation is performed. Here, an example in which a plurality of sub-picture creation processing operations are performed in a serial manner is illustrated. In a case where, for example, a plurality of applications are activated on the display device 1 and the applications are desired to update respective sub-pictures displayed on the display 600, the applications each perform a sub-picture creation processing operation. The sub-picture data created by each of the applications using the sub-picture creation processing operation is not displayed on the display 600 without change, and it is desirable to perform composition processing for superimposing the sub-picture data on a piece of sub-picture data based on another application. Therefore, the created sub-picture data is stored in the first VRAM 220 once.

Next, based on issuing of Vsync1, the composition processing is performed. By the composition processing, picture data is created from the sub-picture data generated based on Vsync1 and stored in the first VRAM 220. The picture data is transferred to the second VRAM 300 after being stored in the first VRAM 220, or the picture data is stored in the second VRAM 300 without being stored in the first VRAM 220. In a case where each application updates the sub-picture after the composition processing is terminated, a sub-picture creation processing operation is subsequently performed, and new sub-picture data is stored in the first VRAM 220. In the example illustrated in FIG. 4, two sub-picture creation processing operations are performed.

Next, based on issuing of Vsync3, picture display processing is performed. Specifically, the picture data generated based on Vsync2 and stored in the second VRAM 300 is displayed in the display 600. In addition, the composition processing regarding the sub-picture data generated based on Vsync2 and stored in the first VRAM 220 is performed. if the composition processing is terminated, a sub-picture creation processing operation is performed in the same way. This example illustrates an example in which only one sub-picture creation processing operation is performed in the unit time period corresponding to Vsync3.

As illustrated in FIG. 4, it is difficult for the composition processing and the sub-picture creation processing to be processed with temporally overlapping with each other. The reason is that both the composition processing and the sub-picture creation processing are executed in the graphics data processing unit 200 including the GPU 210. In order to avoid a state in which both the processing operations compete against each other in the graphics data processing unit 200, when Vsync is issued, the composition processing is performed first, and after that, the sub-picture creation processing is performed. In addition, between a plurality of sub-picture creation processing operations, in order to avoid a state in which processing operations in the graphics data processing unit 200 compete against one another, a processing operation is exclusively performed. In addition, the picture display processing is processing executed by the display controller 500, based on the picture data stored in the second VRAM, and the processing thereof is able to be performed independently from the graphics data processing unit 200. Therefore, the picture display processing is able to be set as processing temporally overlapping with the composition processing or the sub-picture creation processing.

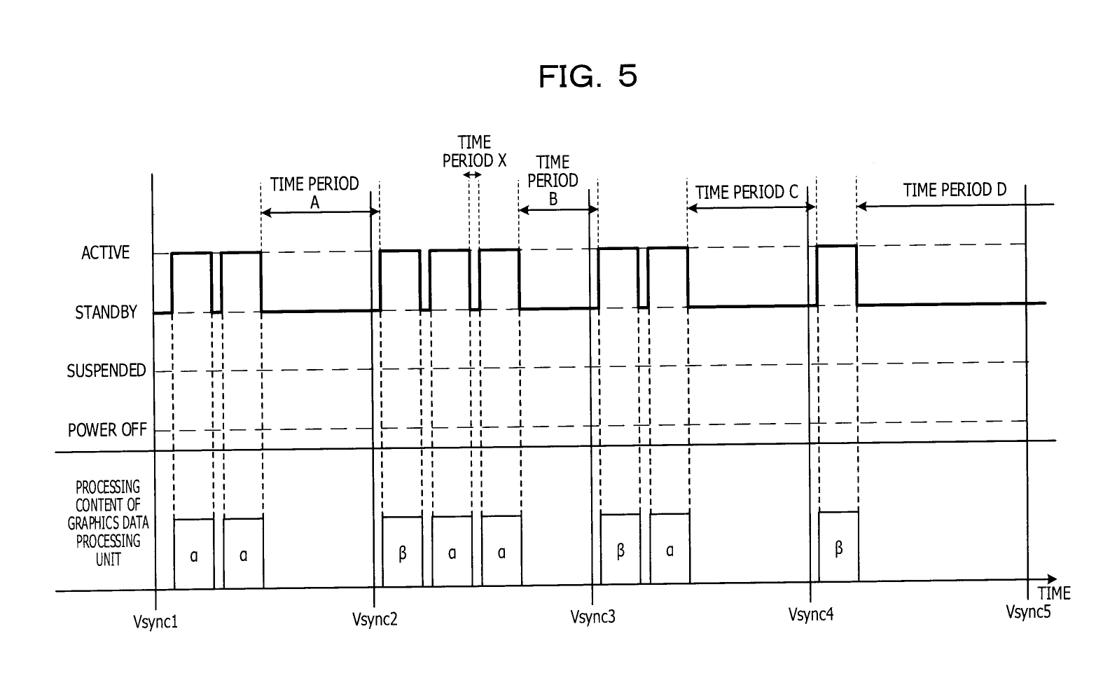

FIG. 5 is a diagram illustrating the operation modes illustrated in FIG. 3 while associating the operation modes with processing illustrated in FIG. 4. It is assumed that the notation of “α” in FIG. 5 means the sub-picture creation processing, and the notation of “β” means the composition processing. In a time period in which the graphics data processing unit 200 executes the sub-picture creation processing, the operation mode of the graphics data processing unit 200 is the active mode. In addition, in a time period in which the graphics data processing unit 200 executes the composition processing, the operation mode thereof is the active mode. On the other hand, in a time period in which the sub-picture creation processing or the composition processing is not performed, the graphics data processing unit 200 is put into the standby mode. Here, in order to reduce electric power consumed in the graphics data processing unit 200, it is conceivable that a time period other than the sub-picture creation processing and the composition processing is controlled so as to be put into the suspended mode or power-off mode whose power consumption is smaller than that of the standby mode. In this regard, however, as illustrated in FIG. 3, it is desirable to consider that it takes longer time for an operation mode whose power consumption is smaller to shift to the active mode. In FIG. 4, for example, it is assumed that the operation mode is caused to shift from the active mode to, for example, the suspended mode when the first sub-picture creation processing operation executed based on Vsync2 is terminated. In this case, it is possible to reduce power consumption, compared with the standby mode. However, in the example illustrated in FIG. 5, it is desirable that the graphics data processing unit 200 executes another sub-picture creation processing operation before the subsequent Vsync3 is issued. Therefore, while it is desirable to return the operation mode from the suspended mode to the active mode, time taken to cause to shift from the suspended mode to the active mode is longer than time taken to cause to shift from the standby mode to the active mode. Therefore, there is a possibility that a time period X represented within FIG. 5 becomes long and the second sub-picture creation processing operation is not completed before issuing of Vsync3. In such a case, there occurs a problem that the delays of the composition processing and the picture display processing, executed based on the subsequent Vsync, are caused by the delay of the sub-picture creation processing operation and it is difficult to smoothly perform picture display in the display 600. Therefore, in the present embodiment, when termination of a sub-picture creation processing operation is detected in each Vsync, it is determined whether or not another sub-picture creation processing operation waiting to be processed exists. In addition, in a case where it is determined that another sub-picture creation processing operation waiting to be processed does not exist, in other words, all sub-picture creation processing operations are executed before the issuing of the subsequent Vsync, the operation mode is shifted to a mode whose power consumption is smaller. From this, it is possible to reduce the power consumption of the graphics data processing unit 200 in a time period A, a time period B, a time period C, and a time period D illustrated in FIG. 5. In addition, in the time period X illustrated in FIG. 5, a sub-picture creation processing operation waiting to be processed exists. Therefore, by putting the operation mode into the standby state in which time taken to shift therefrom to the active mode is shorter than in the other modes, it is possible to avoid stretching of the time period X. A method for confirming the presence or absence of a sub-picture creation processing operation waiting to be processed will be described hereinafter.

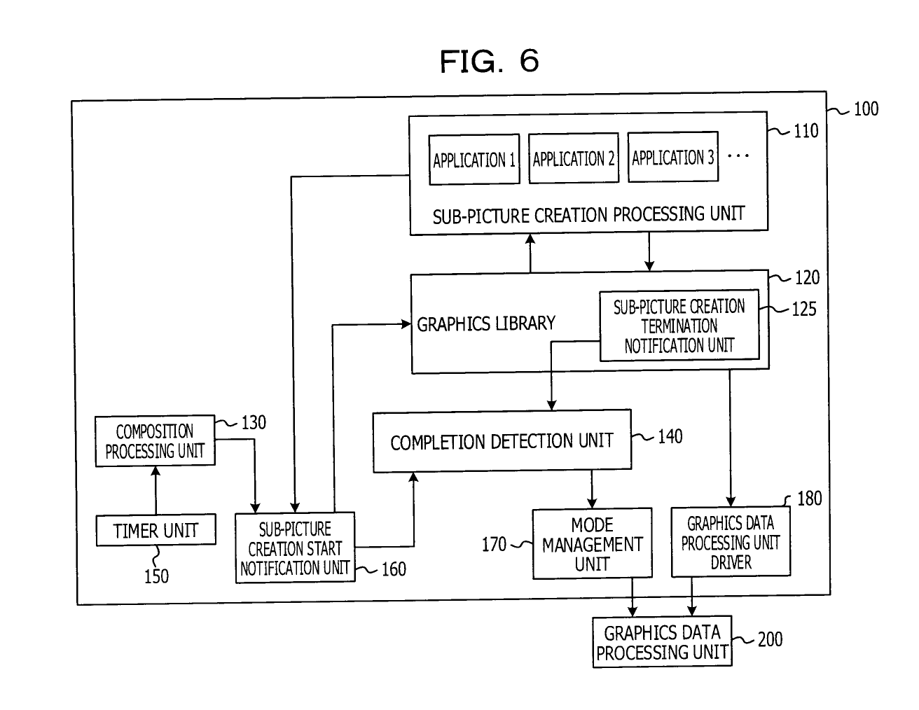

FIG. 6 is the functional block diagram of the CPU 100. By executing a predetermined program stored in another storage device accessible by the memory 400 or the CPU 100, the CPU 100 realizes individual functions illustrated in FIG. 6. The CPU 100 functions as a sub-picture creation processing unit 110, a graphics library 120, a sub-picture creation termination notification unit 125, a composition processing unit 130, a completion detection unit 140, a timer unit 150, a sub-picture creation start notification unit 160, a mode management unit 170, and a graphics data processing unit driver 180.

The sub-picture creation processing unit 110 is realized by an application layer. When applications activated on the display device 1 each update a sub-picture, the sub-picture creation processing unit 110 executes the sub-picture creation processing using the graphics data processing unit 200 through the graphics library 120 and the graphics data processing unit driver 180, and creates new sub-picture data. In addition, before Vsync is issued, the sub-picture creation processing unit 110 notifies the sub-picture creation start notification unit 160 of an application desired to update a sub-picture, using a callback function or the like. In a case where, for example, an application 1 and an application 2 are desired to update sub-pictures, the sub-picture creation processing unit 110 gives notice to the sub-picture creation start notification unit 160 so as to urge the sub-picture creation start notification unit 160 to send sub-picture creation start notices to the application 1 and the application 2 at the time of a timing of being capable of starting sub-picture creation. Based on the notice from the sub-picture creation processing unit 110, the sub-picture creation start notification unit 160 stores destinations to which the sub-picture creation start notices are to be sent.

The timer unit 150 is realized by a kernel layer, issues Vsync at predetermined time intervals, and sends Vsync to the composition processing unit 130. The composition processing unit 130 is realized by a service layer, and performs, based on Vsync sent from the timer unit 150, composition processing for sub-picture data created by the sub-picture creation processing unit 110. If the composition processing for the sub-picture data is terminated, a termination notice of the composition processing is sent to the sub-picture creation start notification unit 160.

The sub-picture creation start notification unit 160 is realized by the kernel layer. Upon receiving the termination notice of the composition processing from the composition processing unit 130, the sub-picture creation start notification unit 160 distributes the sub-picture creation start notices to applications to perform sub-picture creation processing operations, the applications being previously given notice of by the sub-picture creation processing unit 110. This distribution of the sub-picture creation start notices to applications may be performed through the graphics library 120 as illustrated in FIG. 6, and the sub-picture creation start notices may be distributed to applications in the sub-picture creation processing unit 110 not through the graphics library 120. In addition, the sub-picture creation start notification unit 160 notifies the completion detection unit 140 of the number of applications to perform sub-picture creation processing operations, previously given notice of by the sub-picture creation processing unit 110, as the scheduled number of sub-pictures serving as the number of sub-pictures to be created within the unit time period corresponding to the relevant Vsync.

The sub-picture creation termination notification unit 125 provided in the graphics library 120 detects the termination of each sub-picture creation processing operation, and transmits a sub-picture creation processing termination notice to the completion detection unit 140. Based on the scheduled number of sub-pictures previously given notice of by the sub-picture creation start notification unit 160 and the number of sub-picture creation termination notices received from the sub-picture creation termination notification unit 125, in other words, the number of actually created sub-pictures, the completion detection unit 140 detects that all sub-picture creation processing operations to be processed within the unit time period corresponding to the relevant Vsync are terminated, and sends a completion notice to the mode management unit 170.

Based on the received completion notice, the mode management unit 170 realized by the kernel layer performs control of the operation mode of the graphics data processing unit 200.

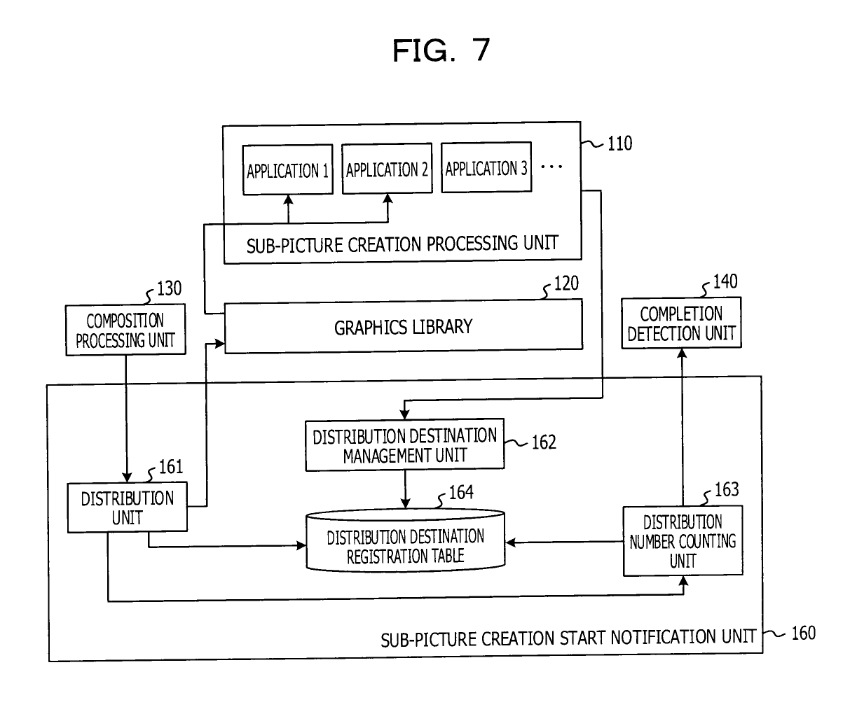

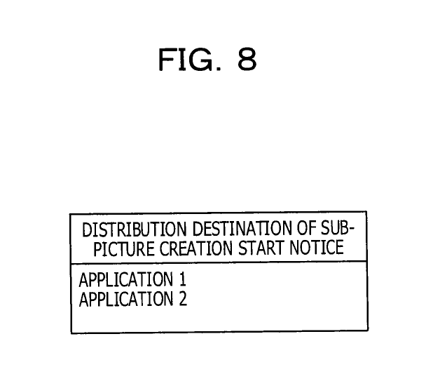

FIG. 7 is the functional block diagram of the sub-picture creation start notification unit 160. The sub-picture creation start notification unit 160 includes a distribution unit 161, a distribution destination management unit 162, and a distribution number counting unit 163. In addition, the sub-picture creation start notification unit 160 holds a distribution destination registration table 164. Using the callback function or the like, the distribution destination management unit 162 receives information for identifying applications to perform sub-picture creation processing operations, based on the subsequently issued Vsync. Based on the relevant received information, the distribution destination management unit 162 creates the distribution destination registration table 164. The distribution destination registration table 164 is a table in which information for identifying applications to perform sub-picture creation is stored, and is information for identifying an application to be a destination to which a sub-picture creation start instruction is to be sent. FIG. 8 is an example of the distribution destination registration table 164. Here, an example in which the application 1 and the application 2 are registered as the distribution destinations of the sub-picture creation start notices is illustrated. In FIG. 7, upon receiving a termination notice of composition processing from the composition processing unit 130, the distribution unit 161 instructs the distribution number counting unit 163 to count a distribution number. The distribution number counting unit 163 references the distribution destination registration table 164 in accordance with the instruction from the distribution unit 161, and identifies the distribution number of sub-picture creation start notices. In the example illustrated in FIG. 8, the distribution number is “2”. The distribution number counting unit 163 notifies the completion detection unit 140 of the identified distribution number.

On the other hand, by referencing the distribution destination registration table 164, the distribution unit 161 identifies applications to serve as the distribution destinations of sub-picture creation start notices. In addition, through the graphics library 120, the sub-picture creation start notices are distributed to the identified applications in the sub-picture creation processing unit 110.

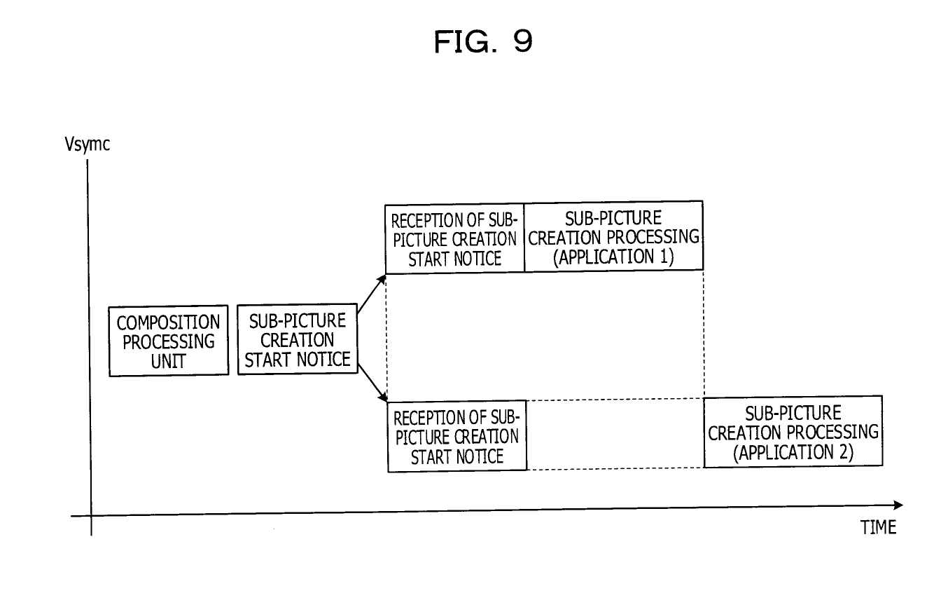

FIG. 9 is a diagram explaining a processing timing when a plurality of applications each receive a sub-picture creation start notice. Subsequent to processing in the composition processing unit 130, the sub-picture creation start notices are sent from the sub-picture creation start notification unit 160 to the identified applications registered in the distribution destination registration table 164 in advance. These sub-picture creation start notices are received by the respective applications. However, as described above, the sub-picture creation processing operation is a processing operation executed using the GPU 210 in the graphics data processing unit 200, and exclusion processing for avoiding competition between a plurality of sub-picture creation processing operations in the GPU 210 is performed. Therefore, in the example in FIG. 9, first a sub-picture creation processing operation based on the application 1 is performed, and after the sub-picture creation processing operation based on the application 1 is terminated, a sub-picture creation processing operation based on the application 2 is performed.

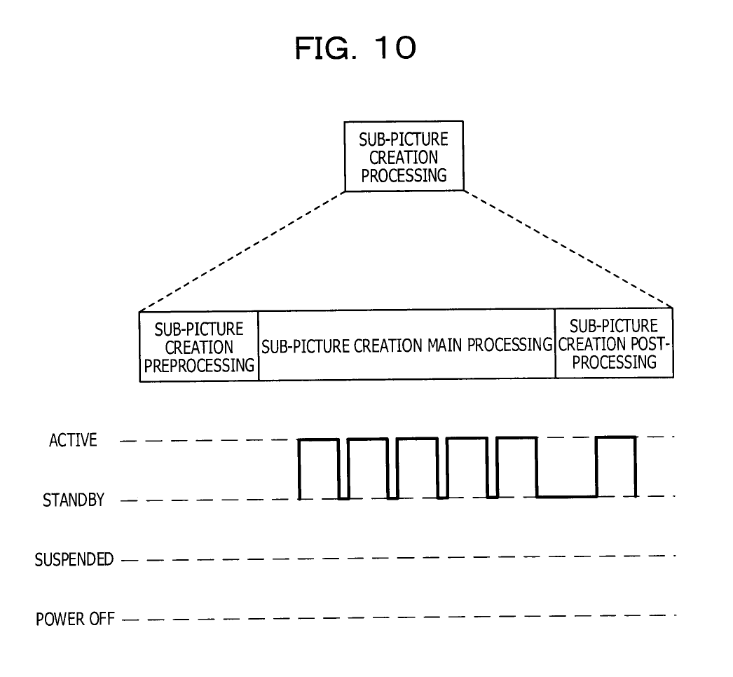

FIG. 10 is a diagram illustrating details of a sub-picture creation processing operation based on each application. The sub-picture creation processing includes sub-picture creation preprocessing, sub-picture creation main processing, and sub-picture creation post-processing. As examples of the sub-picture creation preprocessing, selection of a drawing to serve as the background of a sub-picture, data erasing in a memory area to be used, and so forth may be cited. If the sub-picture creation preprocessing is terminated, sub-picture data is formed by the sub-picture creation main processing. The sub-picture data is stored in a specific area in the first VRAM 220. After the sub-picture creation main processing is terminated, the sub-picture creation post-processing is performed. As an example of the sub-picture creation post-processing, a work for switching a data storage area in the first VRAM 220 may be cited. The switching a data storage area means a work for switching a data area within the first VRAM, used for storing therein the sub-picture data created by the sub-picture creation processing unit 110. Specifically, in a case where the sub-picture data created by the sub-picture creation processing unit 110 is stored in the first VRAM 220, a first data storage area is released for the composition processing unit 130 after the sub-picture data is stored in the first data storage area in the first VRAM 220. The sub-picture creation processing unit 110 stores subsequently created sub-picture data in a second data storage area in the first VRAM 220. After storing the sub-picture data in the second data storage area, the sub-picture creation processing unit 110 releases the second data storage area for the composition processing unit 130, and stores sub-picture data in the first data storage area again. In this way, after the sub-picture creation main processing is terminated, the work for switching the data storage area in the first VRAM 220 is performed as the sub-picture creation post-processing. In this regard, however, the sub-picture creation post-processing is not limited to the work for switching the data storage area described here. As described below, if being processing able to be used for detecting the termination of the sub-picture creation processing, another type of sub-picture creation post-processing is applicable to the present embodiment.

Note that examples illustrated in the lower stage of FIG. 10 are examples of the operation modes of the graphics data processing unit 200 in the sub-picture creation preprocessing, the sub-picture creation main processing, and the sub-picture creation post-processing. In a case where the GPU 210 does not perform data processing in the sub-picture creation preprocessing, the operation mode is put into the standby mode, and a time period in the GPU 210 performs data processing in the sub-picture creation main processing corresponds to the active mode. In addition, in the sub-picture creation post-processing, an operation mode becomes active at a timing when the GPU 210 performs desired processing. Note that, in the middle of the sub-picture creation main processing, in a state in which the GPU 210 completes processing for data to be processed and the GPU 210 waits for data to be subsequently processed, the operation mode is put into the standby mode.

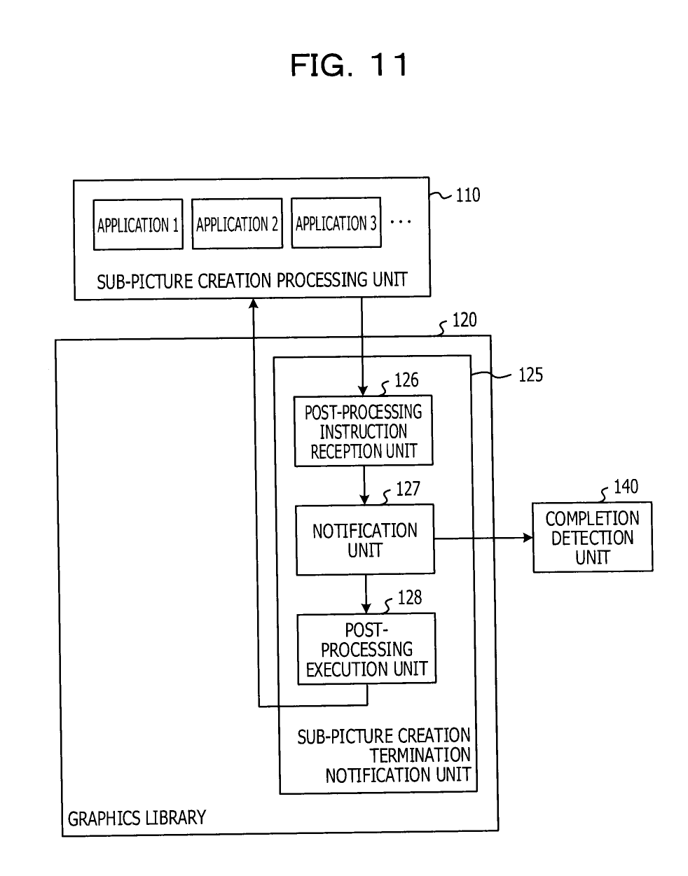

FIG. 11 is the functional block diagram of the sub-picture creation termination notification unit 125 provided in a library layer. The sub-picture creation termination notification unit 125 includes a post-processing instruction reception unit 126, a notification unit 127, and a post-processing execution unit 128. After the sub-picture creation main processing illustrated in FIG. 10 is terminated, the sub-picture creation processing unit 110 sends a post-processing instruction to the sub-picture creation termination notification unit 125. This post-processing instruction is an instruction individually sent by an application that stores created sub-picture data in a predetermined data storage area in the first VRAM 220, and in a case where a plurality of applications each create sub-picture data, the applications each send the post-processing instruction. If the post-processing instruction reception unit 126 receives the post-processing instruction from the sub-picture creation processing unit 110, the notification unit 127 notifies the completion detection unit 140 of the termination of the relevant sub-picture creation processing. This notice is called a sub-picture creation termination notice. This sub-picture creation termination notice is a notice for indicating that an individual piece of sub-picture data is created, and is different from a completion notice issued by the after-mentioned completion detection unit 140 when all pieces of sub-picture data are created. After the notification unit 127 issues the sub-picture creation termination notice, the post-processing execution unit 128 executes the sub-picture creation post-processing, and informs the sub-picture creation processing unit 110 to the effect that the sub-picture creation post-processing is executed.

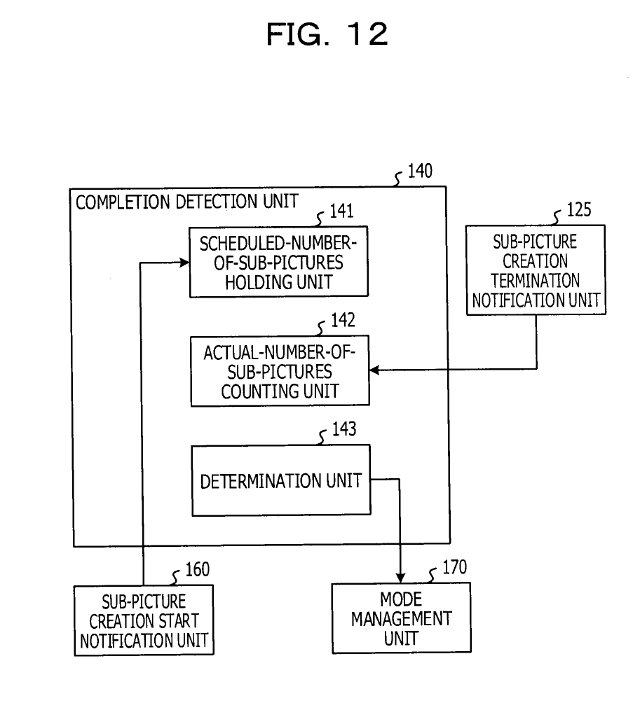

FIG. 12 is the functional block diagram of the completion detection unit 140. The completion detection unit 140 includes a scheduled-number-of-sub-pictures holding unit 141, an actual-number-of-sub-pictures counting unit 142, and a determination unit 143. The scheduled-number-of-sub-pictures holding unit 141 holds the scheduled number of sub-pictures previously given notice of by the sub-picture creation start notification unit 160. The actual-number-of-sub-pictures counting unit 142 counts the number of sub-picture creation processing termination notices received from the sub-picture creation termination notification unit 125. The determination unit 143 determines whether or not the number held in the scheduled-number-of-sub-pictures holding unit 141 and the number counted by the actual-number-of-sub-pictures counting unit 142 coincide with each other. In a case where the number held in the scheduled-number-of-sub-pictures holding unit 141 and the number counted by the actual-number-of-sub-pictures counting unit 142 coincide with each other, it is determined that all the sub-picture creation processing operations to be processed within the unit time period corresponding to the relevant Vsync are terminated, and a completion notice is sent to the mode management unit 170.

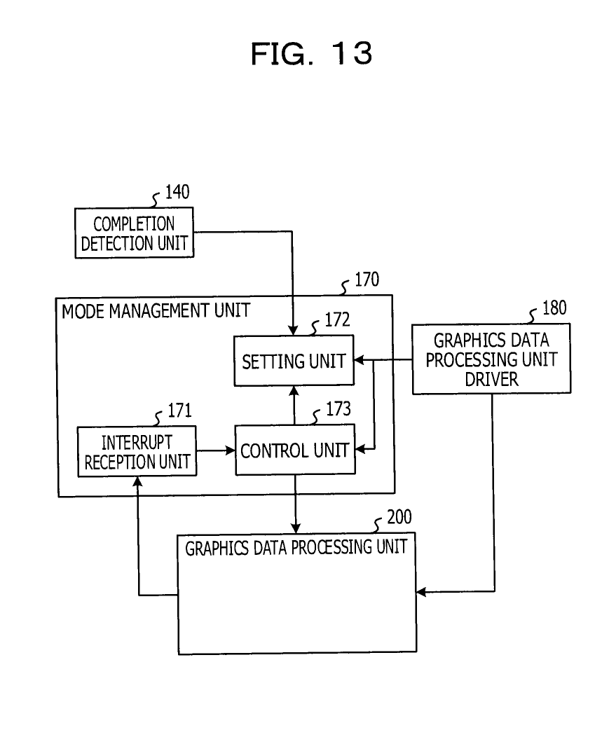

FIG. 13 is the functional block diagram of the mode management unit 170. The mode management unit 170 includes an interrupt reception unit 171, a setting unit 172, and a control unit 173. The interrupt reception unit 171 receives an interrupt notice of processing termination from the GPU 210 within the graphics data processing unit 200. When data processing relating to, for example, the sub-picture creation processing is performed, if processing for data assigned to the GPU 210 is performed and a state in which no data to be processed by the GPU 210 exists occurs, the GPU 210 sends the interrupt notice of processing termination to the mode management unit 170. In addition, when the sub-picture creation post-processing described in FIG. 10 and FIG. 11 is executed, the interrupt notice of termination from the GPU 210 is issued. Upon receiving the interrupt notice, the interrupt reception unit 171 instructs the control unit 173 to switch the operation mode of the graphics data processing unit 200. Upon receiving the instruction to switch the operation mode, the control unit 173 references an operation mode set in the setting unit 172. In the setting unit 172, the operation mode of the graphics data processing unit 200 is set. In a case where, for example, the “standby mode” is set in the setting unit 172, the control unit 173 switches the operation mode of the graphics data processing unit 200 to the standby mode.

In a case of causing the graphics data processing unit 200 to newly perform data processing, the graphics data processing unit driver 180 transmits desired data to the graphics data processing unit 200, and notifies the control unit 173 of start of the data processing. From this, the control unit 173 shifts the operation mode from the standby mode to the active mode, and the data processing in the graphics data processing unit 200 is started.

If, in such control, the completion detection unit 140 issues a completion notice corresponding to the sub-picture creation post-processing operation of a final sub-picture creation processing operation out of sub-picture creation processing operations to be executed within the unit time period corresponding to certain Vsync, the setting unit 172 changes the set operation mode, for example, from the “standby mode” to the “suspended mode”. After that, the interrupt notice of processing termination, specifically, the interrupt notice of processing termination associated with execution of the sub-picture creation post-processing operation of the final sub-picture creation processing operation is issued from the graphics data processing unit 200. The control unit 173 references the setting unit 172, and performs control so as to put the operation mode of the graphics data processing unit 200 into the suspended mode, in accordance with it that the set operation mode is the “suspended mode”. In a case where, based on such a series of operations, all the sub-picture creation processing operations to be performed in response to each Vsync are terminated, it becomes possible to shift the operation mode of the graphics data processing unit 200 to a mode whose power consumption is smaller.

In addition, in a case where a new composition processing operation or a new sub-picture creation processing operation is caused to occur by the subsequent Vsync, the graphics data processing unit driver 180 transmits desired data to the graphics data processing unit 200, and notifies the control unit 173 of start of data processing. From this, the control unit 173 shifts the operation mode from the suspended mode to the active mode, and the data processing in the graphics data processing unit 200 is resumed. In addition, at this time, the graphics data processing unit driver 180 performs processing for returning the setting of the setting unit 172 from the “suspended mode” to the “standby mode”. From this, in a case where the interrupt notice of processing termination occurs from the graphics data processing unit 200 next, the operation mode turns out to be switched not to the suspended mode but to the standby mode.

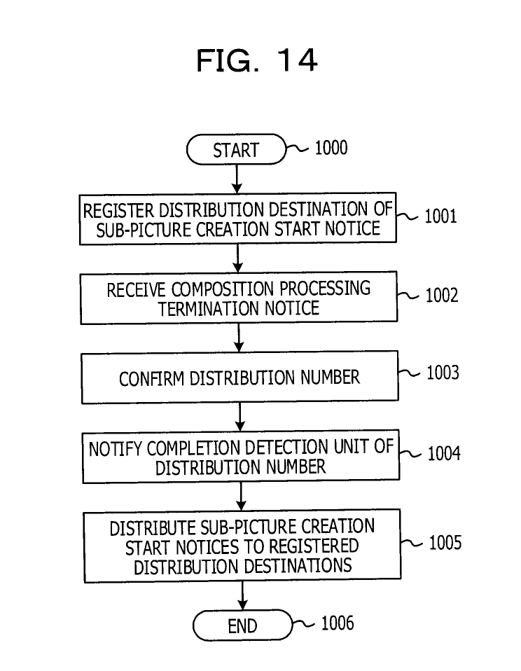

FIG. 14 is the flowchart of processing performed by the sub-picture creation start notification unit 160. The processing performed by the sub-picture creation start notification unit 160 is started by a processing operation 1000. In a processing operation 1001, based on a notice from the sub-picture creation processing unit 110, the distribution destination management unit 162 registers an application to serve as the distribution destination of a sub-picture creation start notice, in the distribution destination registration table 164. In a processing operation 1002, the distribution unit 161 receives the termination notice of composition processing from the composition processing unit 130. In a processing operation 1003, by referencing the distribution destination registration table 164, the distribution number counting unit 163 confirms the distribution number of sub-picture creation start notices. In a processing operation 1004, the distribution number counting unit 163 notifies the completion detection unit 140 of the distribution number of sub-picture creation start notices. In a processing operation 1005, the distribution unit 161 distributes sub-picture creation start notices to applications registered in the distribution destination registration table 164, and the processing is terminated in a processing operation 1006.

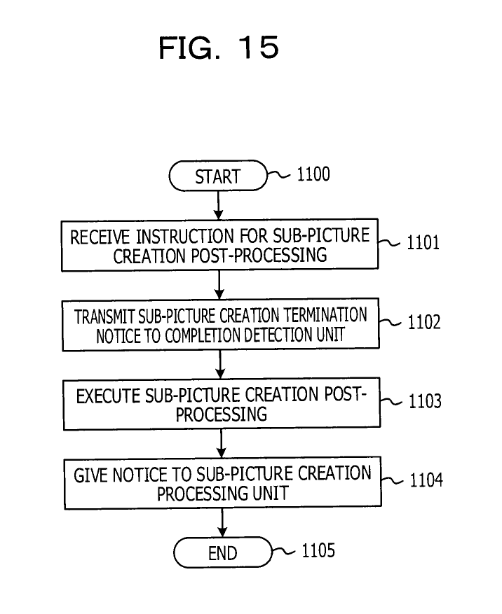

FIG. 15 is the flowchart of processing performed by the sub-picture creation termination notification unit 125. The processing performed by the sub-picture creation termination notification unit 125 is started by a processing operation 1100. In a processing operation 1101, the post-processing instruction reception unit 126 receives an instruction to execute the sub-picture creation post-processing from the sub-picture creation processing unit 110. In a processing operation 1102, the notification unit 127 transmits a sub-picture creation termination notice to the completion detection unit 140. In a processing operation 1103, the post-processing execution unit 128 executes the sub-picture creation post-processing. In a processing operation 1104, the post-processing execution unit 128 informs the sub-picture creation processing unit 110 to the effect that post-processing is terminated, and the processing is terminated in a processing operation 1105.

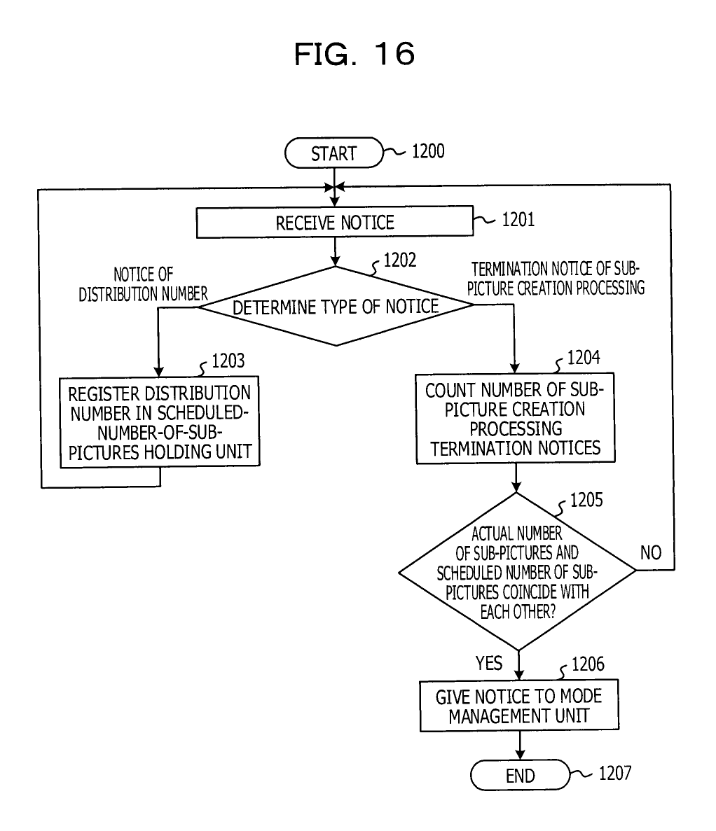

FIG. 16 is the flowchart of processing performed by the completion detection unit 140. The processing performed by the completion detection unit 140 is started by a processing operation 1200. In a processing operation 1201, the completion detection unit 140 receives a notice from the outside. In a processing operation 1202, the completion detection unit 140 determines the type of the notice. In a case where the received notice is the notice of the distribution number of sub-picture creation start signals transmitted from the sub-picture creation start notification unit 160, the processing proceeds to a processing operation 1203. In addition, in a case where the received notice is the termination notice of the sub-picture creation processing transmitted from the sub-picture creation termination notification unit 125, the processing proceeds to a processing operation 1204. In the processing operation 1203, the scheduled-number-of-sub-pictures holding unit 141 holds the distribution number of sub-picture creation start notices, given notice of, as the scheduled number of sub-pictures of the sub-picture creation processing, and the processing returns to the processing operation 1201. In the processing operation 1204, the actual-number-of-sub-pictures counting unit 142 counts the number of received sub-picture creation processing termination notices, as the actual number of sub-pictures serving as the number of actually created sub-pictures. In a processing operation 1205, the determination unit 143 determines whether or not the scheduled number of sub-pictures held in the scheduled-number-of-sub-pictures holding unit 141 and the actual number of sub-pictures counted by the actual-number-of-sub-pictures counting unit 142 coincide with each other. In a case where it is determined that the scheduled number of sub-pictures and the actual number of sub-pictures do not coincide with each other, the processing returns to the processing operation 1201. In addition, in a case where it is determined that the scheduled number of sub-pictures and the actual number of sub-pictures coincide with each other, the processing proceeds to a processing operation 1206. In the processing operation 1206, the determination unit 143 issues the completion notice of the sub-picture creation processing to the mode management unit 170, and the processing is terminated in a processing operation 1207.

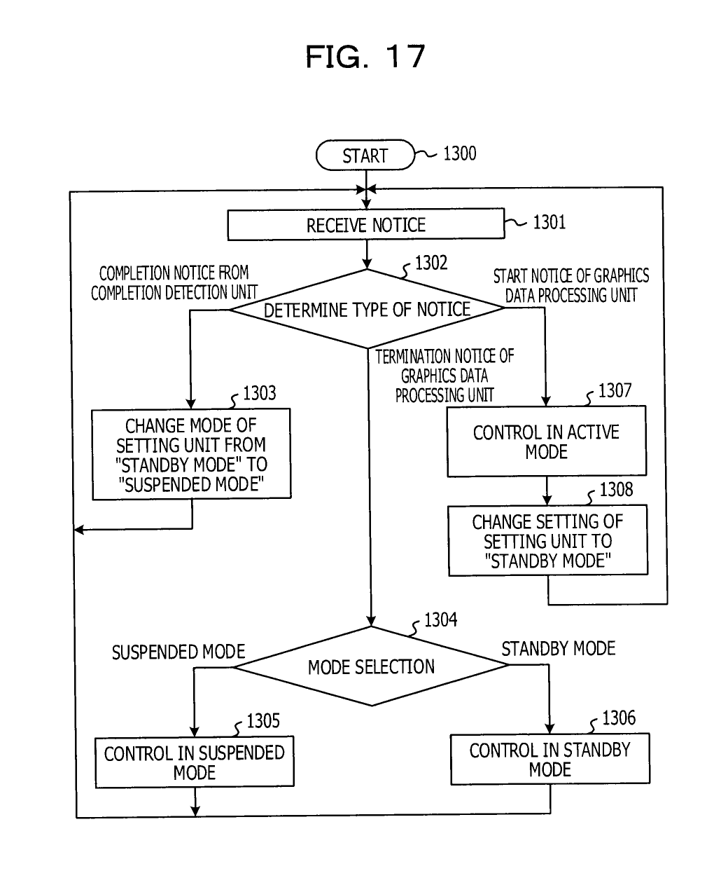

FIG. 17 is the flowchart of processing performed by the mode management unit 170. The processing performed by the mode management unit 170 is started in a processing operation 1300. In a processing operation 1301, the mode management unit 170 receives a notice from the outside. In a processing operation 1302, the mode management unit 170 determines the type of the received notice. In a case where the received notice is a completion notice transmitted from the completion detection unit 140, the processing proceeds to a processing operation 1303. In a case where the received notice is the interrupt notice of processing termination transmitted from the graphics data processing unit 200, the processing proceeds to a processing operation 1304. In addition, in a case where the received notice is a start notice from the graphics data processing unit driver 180, the processing proceeds to a processing operation 1307.

In the processing operation 1303, based on the completion notice from the completion detection unit 140, the setting unit 172 changes the operation mode of the graphics data processing unit 200 from the “standby mode” to the “suspended mode”, and the processing returns to the processing operation 1301. In the processing operation 1304, based on the termination notice from the graphics data processing unit 200 and the setting content of the setting unit 172, the control unit 173 selects the operation mode of the graphics data processing unit 200. In a case where the operation mode set in the setting unit 172 is the “suspended mode”, the suspended mode is selected, and the processing shifts to a processing operation 1305. In addition, in a case where the operation mode set in the setting unit 172 is the “standby mode”, the standby mode is selected, the processing shifts to a processing operation 1306. In the processing operation 1305, the control unit 173 switches the operation mode of the graphics data processing unit 200 to the suspended mode, and the processing returns to the processing operation 1301. In addition, in the processing operation 1306, the control unit 173 switches the operation mode of the graphics data processing unit 200 to the standby mode, and the processing returns to the processing operation 1301.

In the processing operation 1307, based on the start notice transmitted from the graphics data processing unit driver 180, the setting unit 172 controls the graphics data processing unit 200 in the active mode. In a processing operation 1308, in a case where the setting of the operation mode of the graphics data processing unit 200 is put into the “suspended mode”, the setting unit 172 changes the setting to the “standby mode”.

In this way, according to the present embodiment, by recognizing, as the scheduled number of sub-pictures, the number of sub-pictures scheduled to be created within one frame and detecting that the actual number of sub-pictures serving as the number of actually created sub-pictures coincides with the scheduled number of sub-pictures, it is possible to detect that all the sub-picture creation processing operations are terminated. From this, in a time period from the timing of completion detection until at least subsequent Vsync is issued, it is possible to shift the operation mode of the graphics data processing unit 200 to a mode in which power consumption is able to be reduced in such a manner as in the suspended mode or the power-off mode, compared with the standby mode.

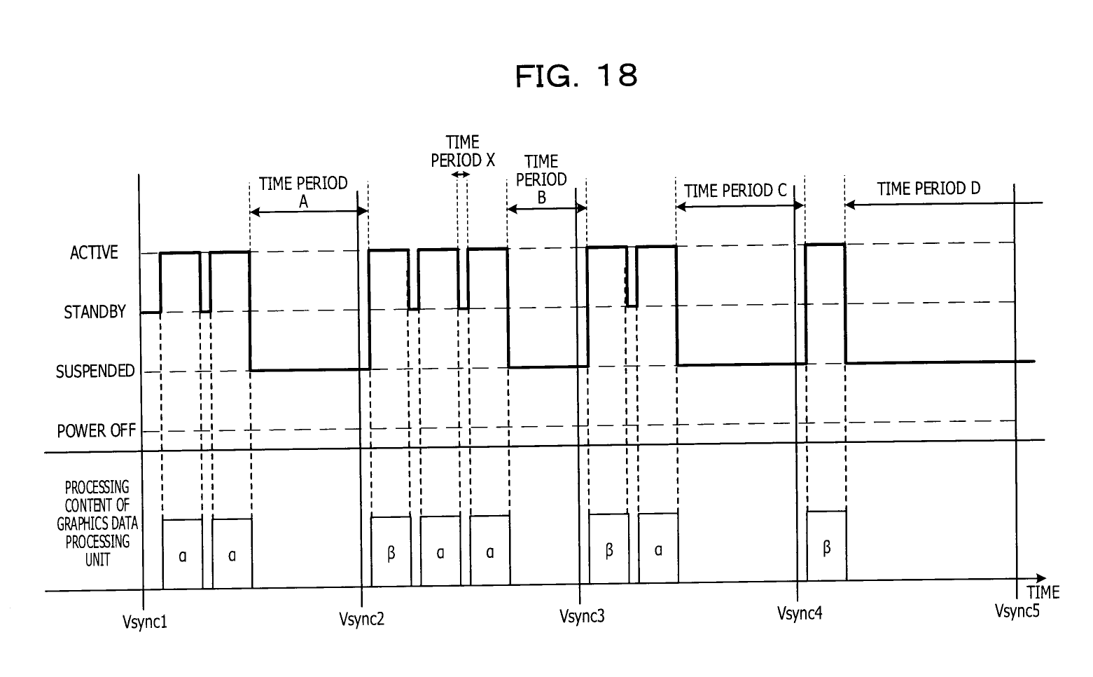

FIG. 18 is a diagram illustrating states in a case where the operation mode of the graphics data processing unit 200 is put into the suspended mode until it becomes desirable to perform subsequent data processing after all data processing operations are terminated. Compared with control of the operation mode illustrated in FIG. 4, the operation mode is put into the suspended mode in the time period A, the time period B, the time period C, and the time period D. Therefore, it is possible to suppress power consumption. In FIG. 18, time taken to shift from the suspended mode to the active mode and time taken to shift from the standby mode to the active mode are not expressed. However, as described in FIG. 3, the time taken to shift from the standby mode to the active mode is longer than the time taken to shift from the suspended mode to the active mode. Therefore, shifting to the suspended mode in a state in which another sub-picture creation processing operation to be executed within the unit time period remains is avoided using the method of the present embodiment, and thus, it is possible to suppress the delay of start or termination of the other sub-picture creation processing operation.

Note that while, in the example of an operation illustrated in FIG. 18, after entering the suspended mode, shifting to the active mode is performed at the start timing of the composition processing started after subsequently issued Vsync, another example of an operation may be considered. After shifting to, for example, the suspended mode, first the operation mode may be shifted from the suspended mode to the standby mode, based on subsequently issued Vsync, and the operation mode may be shifted from the standby mode to the active mode at the time of start of the composition processing. From this, it is possible to suppress the delay of the start timing of the composition processing. In this case, for example, in the mode management unit 170 illustrated in FIG. 13, an alteration is performed so that the setting unit 172 receives Vsync from the timer unit 150, and the operation mode is changed from the suspended mode to the standby mode, based on Vsync. In addition, by performing an alteration so that the interrupt reception unit 171 receives Vsync as an interrupt signal and causing the control unit 173 to switch the operation mode in response to reception of Vsync, it is possible to achieve realization. Furthermore, in this example of an operation, in a case where a time period until subsequent Vsync is issued is smaller than a predetermined threshold value at the time of termination of all the sub-picture creation processing operations, control may be performed so as to maintain the standby mode without changing to the suspended mode.

In addition, while, in FIG. 11, FIG. 13, and FIG. 17, an example of an operation in which first the sub-picture creation termination notification unit 125 issues a sub-picture creation termination notice to the completion detection unit 140 and the sub-picture creation post-processing is performed after that is illustrated, another example of an operation may be considered. For example, the sub-picture creation termination notification unit 125 may perform a sub-picture creation processing termination notice after the sub-picture creation post-processing is terminated. In this case, whole data processing in the graphics data processing unit 200, which includes the sub-picture creation post-processing, is terminated when the mode management unit 170 receives a completion notice from the completion detection unit 140. Therefore, without waiting for the interrupt notice of processing termination from the graphics data processing unit 200, the control unit 173 performs control so as to switch the operation mode to the suspended mode.

In addition, while, in the present embodiment, there is described the method for notifying the completion detection unit 140 of the number of distribution destination applications of sub-picture creation start notices, of which the sub-picture creation start notification unit 160 is notified by the sub-picture creation processing unit 110, another method may be considered. For example, the sub-picture creation processing unit 110 may notify the sub-picture creation start notification unit 160 of distribution destination applications of sub-picture creation start notices and notify the completion detection unit 140 of the same information, and the completion detection unit 140 may directly determine and hold the scheduled number of sub-pictures in the scheduled-number-of-sub-pictures holding unit 141.

Next, as a second embodiment, a method for detecting that all sub-picture creation processing operations are terminated in a case where one application to perform sub-picture creation processing performs a plurality of sub-picture creation processing operations will be disclosed.

Based on an assumption that applications each perform one sub-picture creation processing operation, the first embodiment is described. However, there is a case where one application performs a plurality of sub-picture creation processing operations. The case is a case where, as, for example, a game application, an application displays, on a display, sub-picture data composed of a background sub-picture and a character sub-picture moving on the background sub-picture independently from the background sub-picture, as the sub-picture of the relevant application. In a case where, in this way, one application performs a plurality of sub-picture creation processing operations, the number of applications that perform sub-picture creation processing operations and the number of actually executed sub-picture creation processing operations do not coincide with each other.

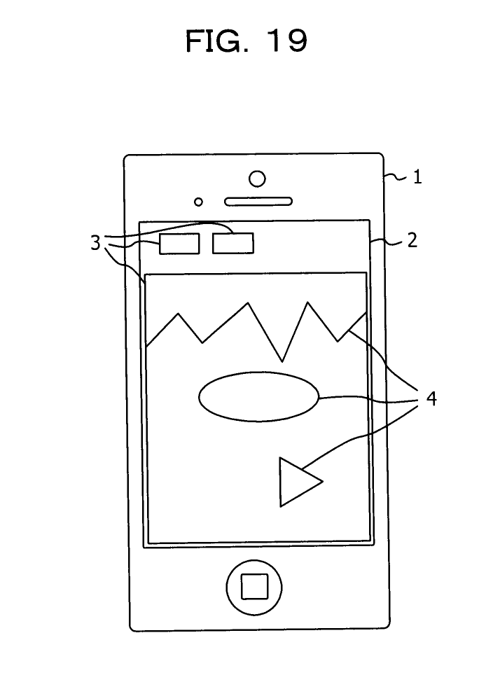

FIG. 19 is a diagram explaining definitions of terms used in the second embodiment. FIG. 19 illustrates the display device 1 in the same way as FIG. 1. In the same way as in the first embodiment, a whole image displayed in the display 2 is called a “picture”, and images 3 drawn by respective applications are “sub-pictures”. Furthermore, a plurality of objects 4 configuring one “sub-picture” are called “elemental sub-pictures”.

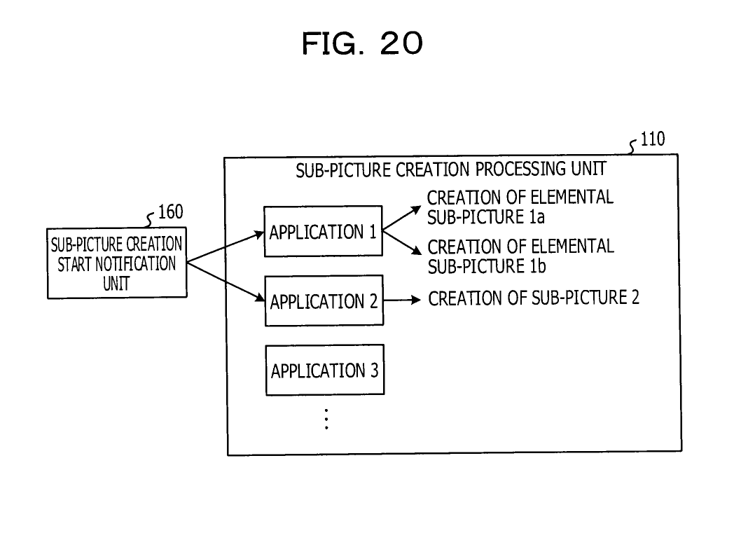

FIG. 20 is a diagram explaining the total number of sub-picture creation processing operations in a case where one application performs two or more sub-picture creation processing operations. In a case where the application 1 and the application 2 are registered in the distribution destination registration table 164 in the sub-picture creation start notification unit 160, a sub-picture creation start notice is distributed to each of the application 1 and the application 2. It is assumed that the application 1 and the application 2 create a sub-picture 1 and a sub-picture 2, respectively, and the application 1 creates an elemental sub-picture 1a and an elemental sub-picture 1b included in the sub-picture 1, in order to create the sub-picture 1. In this case, sub-picture creation processing operations whose total number is three are performed by the application 1 and the application 2. In the second embodiment, in a case where one application performs two or more sub-picture creation processing operations, the completion timing of the graphics data processing unit 200 is adequately understood. Note that, in the present embodiment, it is assumed that “the number of sub-pictures” means the number of sub-pictures including the elemental sub-pictures and the total number of created sub-pictures is counted as “3” in a case where, as the above-mentioned example, the application 1 creates the elemental sub-picture 1a and the elemental sub-picture 1b and the application 2 creates the sub-picture 2. In other words, the number of sub-pictures becomes equal to the number of times the sub-picture creation processing is performed.

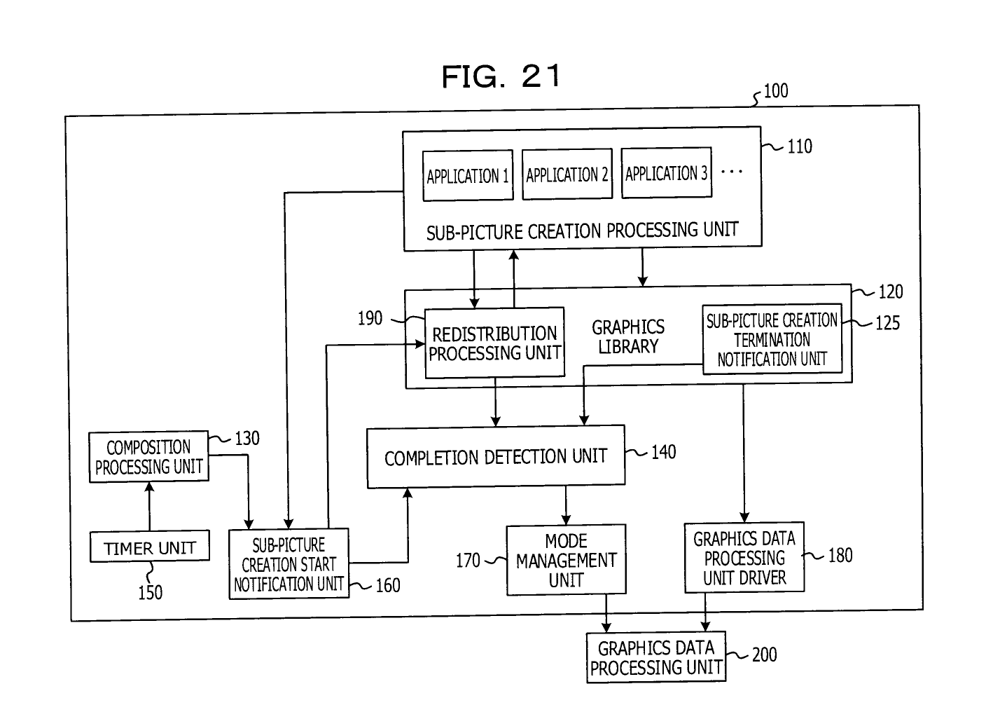

FIG. 21 is the functional block diagram of the CPU 100 in the second embodiment. A same reference symbol is assigned to the same functional block as the functional block disclosed in the first embodiment, and the description thereof will be omitted. The CPU 100 functions as a redistribution processing unit 190 realized by the library layer, in addition to the sub-picture creation processing unit 110, the graphics library 120, the sub-picture creation termination notification unit 125, the composition processing unit 130, the completion detection unit 140, the timer unit 150, the sub-picture creation start notification unit 160, the mode management unit 170, and the graphics data processing unit driver 180. The redistribution processing unit 190 has a function for redistributing a sub-picture creation start notice transmitted from the sub-picture creation start notification unit 160, to an application in the sub-picture creation processing unit 110. In addition, in a case where, for example, a thread 1a included in the application 1 creates the elemental sub-picture 1a and a thread 1b included therein creates the elemental sub-picture 1b, the redistribution processing unit 190 transmits sub-picture creation start notices to the respective threads. Furthermore, the redistribution processing unit 190 notifies the completion detection unit 140 of the number of sub-pictures, which increases by the execution of the redistribution.

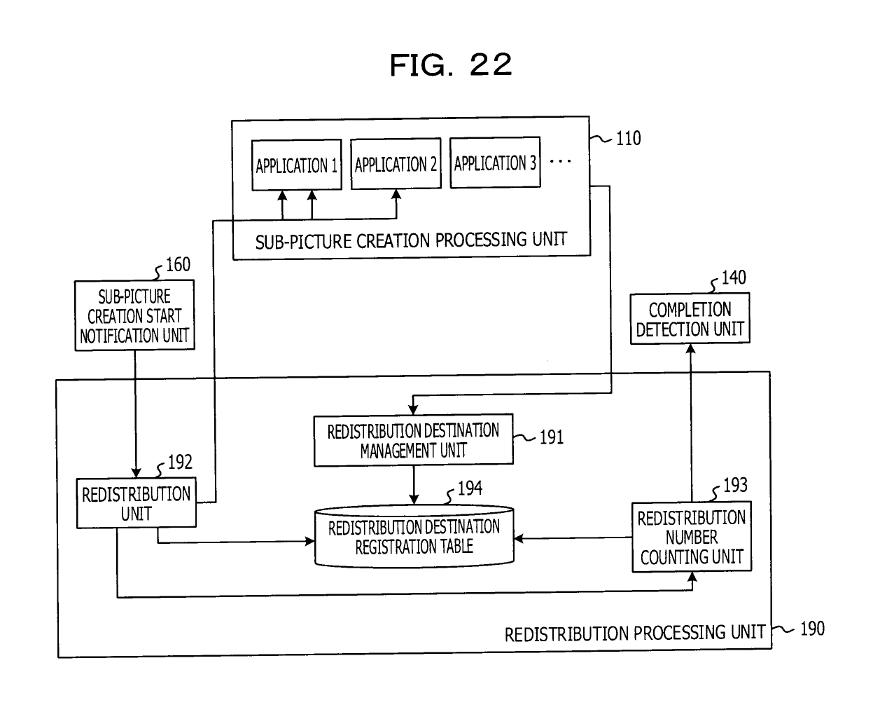

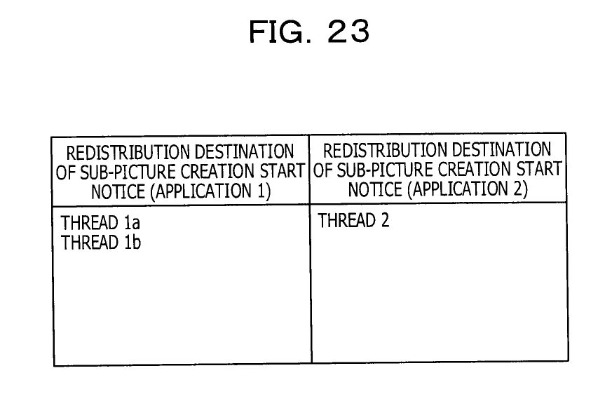

FIG. 22 is the functional block diagram of the redistribution processing unit 190. The redistribution processing unit 190 includes a redistribution destination management unit 191, a redistribution unit 192, and a redistribution number counting unit 193. In addition, the redistribution processing unit 190 holds a redistribution destination registration table 194. The redistribution destination management unit 191 receives, from the sub-picture creation processing unit 110, information relating to a redistribution destination with respect to each application to update a sub-picture, in other words, each application to perform a sub-picture creation processing operation, based on subsequently issued Vsync. Based on the relevant received information, the redistribution destination management unit 191 creates the redistribution destination registration table 194. The redistribution destination registration table 194 is a table for identifying a redistribution destination with respect to each application to perform sub-picture creation. FIG. 23 illustrates an example of the redistribution destination registration table 194. In this table, as redistribution destinations, the thread is and the thread 1b, included in the application 1, and a thread 2 included in the application 2 are registered. In FIG. 22, upon receiving a sub-picture creation start notice from the sub-picture creation start notification unit 160, the redistribution unit 192 instructs the redistribution number counting unit 193 to count a redistribution number. In accordance with the instruction from the redistribution unit 192, the redistribution number counting unit 193 references the redistribution destination registration table 194, and identifies the distribution number of sub-picture creation start notices. In the example illustrated in FIG. 23, the redistribution number is “3”. The redistribution number counting unit 193 notifies the completion detection unit 140 of “1” serving as a value obtained by subtracting “2” serving as the number of registered applications from the redistribution number, as an addition value. This means that, by performing redistribution, the number of created sub-pictures increases by “1”. The completion detection unit 140 adds the addition value “1” given notice of by the redistribution processing unit 190, to “2” serving as a value given notice of by the sub-picture creation start notification unit 160 and held in the scheduled-number-of-sub-pictures holding unit 141, and holds “3” in the scheduled-number-of-sub-pictures holding unit 141, as the final scheduled number of sub-pictures.

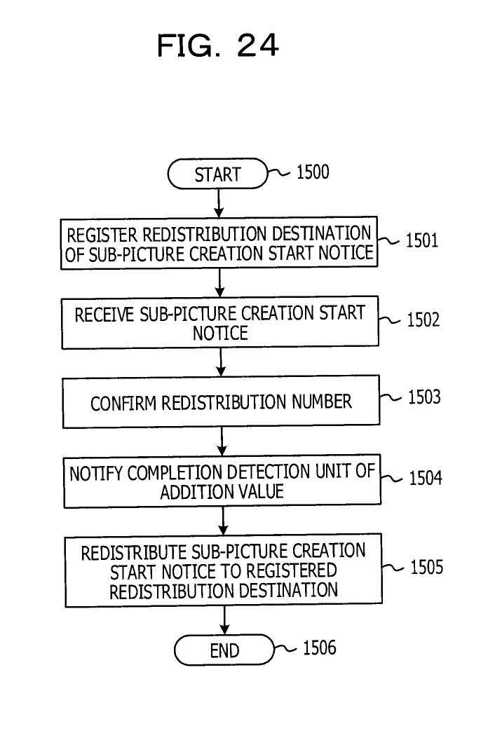

FIG. 24 is the flowchart of processing performed by the redistribution processing unit 190. The processing performed by the redistribution processing unit 190 is started by a processing operation 1500. In a processing operation 1501, based on a notice from the sub-picture creation processing unit 110, the redistribution destination management unit 191 identifies and registers the redistribution destination of a sub-picture creation start notice, in the redistribution destination registration table 194. In a processing operation 1502, the redistribution unit 192 receives a sub-picture creation start notice from the sub-picture creation start notification unit 160. In a processing operation 1503, by referencing the redistribution destination registration table 194, the redistribution number counting unit 193 confirms the redistribution number of sub-picture creation start notices. In a processing operation 1504, the redistribution number counting unit 193 notifies the completion detection unit 140 of the addition value of the scheduled number of sub-pictures. In a processing operation 1505, the redistribution processing unit 190 redistributes a sub-picture creation start notice to a thread serving as a redistribution destination registered in the redistribution destination registration table 194, and terminates the processing in a processing operation 1506.

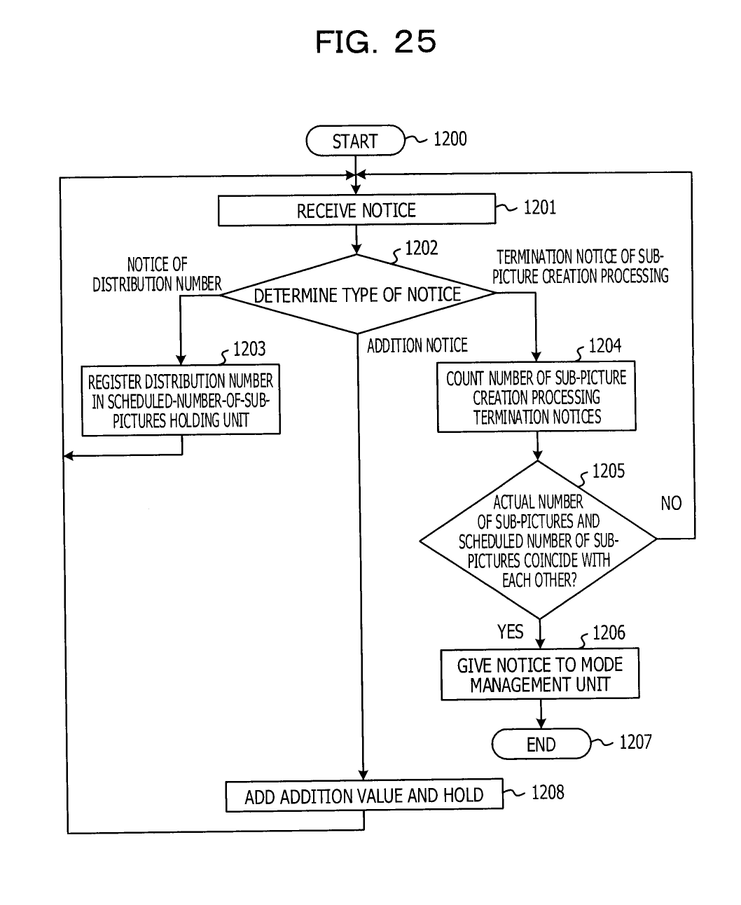

FIG. 25 is the flowchart of processing performed by the completion detection unit 140 in the second embodiment. A same symbol is assigned to the same processing operation as the processing operation of the completion detection unit 140 in the first embodiment, and the description thereof will be omitted. In addition to the processing operations in the first embodiment, a processing operation 1208 is further performed. In a case where, in the determination of the type of a notice, performed in the processing operation 1202, a notice is an addition notice from the redistribution processing unit 190, the scheduled-number-of-sub-pictures holding unit 141 holds, as a new scheduled number of sub-pictures, a value obtained by adding the addition value to the held scheduled number of sub-pictures, in the processing operation 1208.

From this, even in a case where one application performs two or more sub-picture creation processing operations, it is possible to adequately understand the total number of sub-picture creation processing operations, and using the completion detection unit 140, it is possible to detect that all the sub-picture creation processing operations are terminated.

Next, an example of a modification to the second embodiment will be disclosed. In FIG. 21 to FIG. 25, an example in which the redistribution processing unit 190 notifies the completion detection unit 140 of the number of sub-pictures, which increases by the redistribution, is disclosed. Here, an example in which a single sub-picture creation termination notice is transmitted to the completion detection unit 140 at the time of termination of all sub-picture creation processing operations executed based on redistribution in a case where the redistribution is performed on one application will be described.

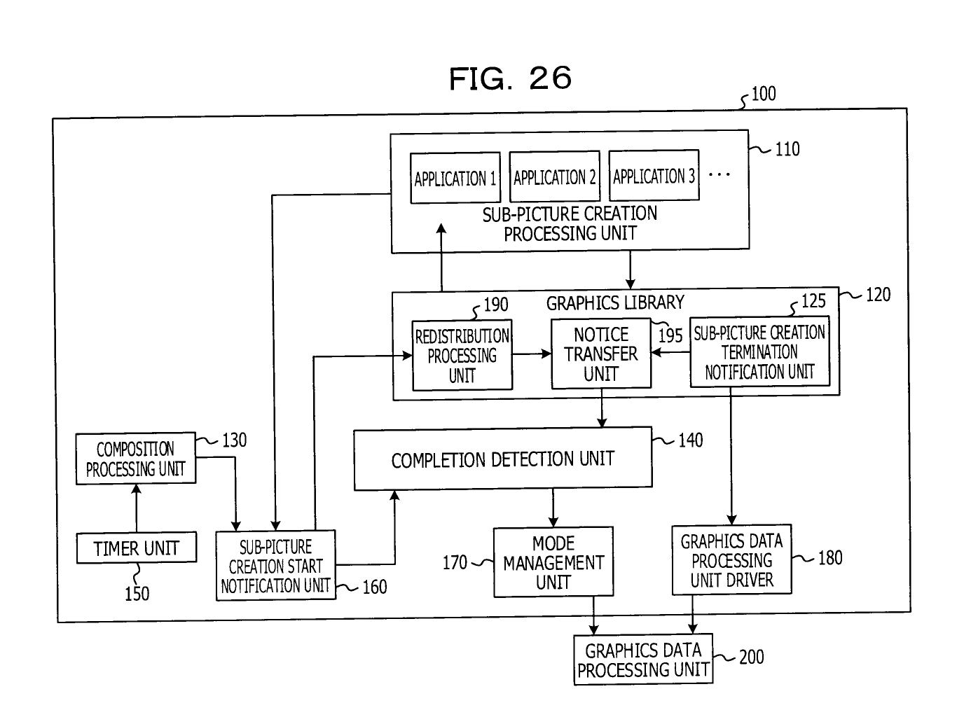

FIG. 26 is the functional block diagram of the CPU 100 in the example of a modification to the second embodiment. A same reference symbol is assigned to the same functional block as the functional block disclosed in the second embodiment, and the description thereof will be omitted. The CPU 100 functions as a notice transfer unit 195 realized by the library layer, in addition to the functions illustrated in FIG. 21. Based on information relating to the redistribution number obtained from the redistribution processing unit 190 and a sub-picture creation termination notice received from the sub-picture creation termination notification unit 125, the notice transfer unit 195 transfers a sub-picture creation termination notice to the completion detection unit 140 in a case where the sub-picture creation processing in each application is terminated. In a case where, for example, the application 1 creates the elemental sub-picture 1a and the elemental sub-picture 1b, the notice transfer unit 195 sends a single sub-picture creation processing termination notice to the completion detection unit 140 when both the elemental sub-picture 1a and the elemental sub-picture 1b are created.

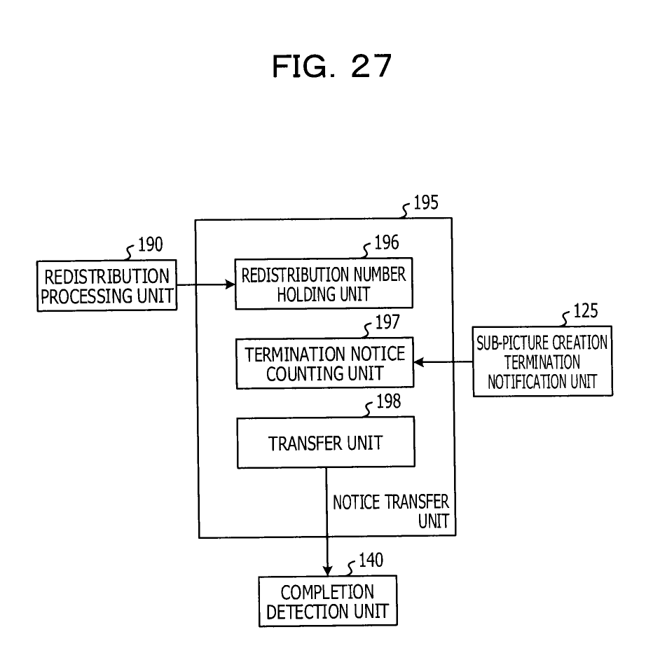

FIG. 27 is the functional block diagram of the notice transfer unit 195 in the example of a modification to the second embodiment. The notice transfer unit 195 includes a redistribution number holding unit 196, a termination notice counting unit 197, and a transfer unit 198. The termination notice transfer unit 195 holds, in the redistribution number holding unit 196, the redistribution number of each application given notice of by the redistribution processing unit 190. With respect to each application, the termination notice counting unit 197 counts the number of sub-picture creation processing termination notices received from the sub-picture creation termination notification unit 125. With respect to each application, in a case where the number held in the redistribution number holding unit 196 and the number counted by the termination notice counting unit 197 coincide with each other, the transfer unit 198 determines that all sub-picture creation processing operations are terminated, and transfers a sub-picture creation processing termination notice to the completion detection unit 140.

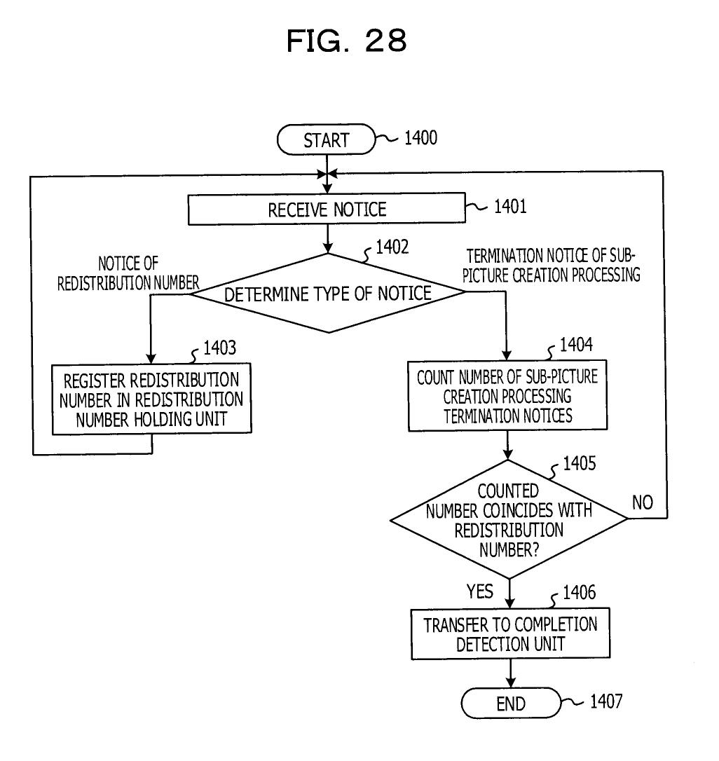

FIG. 28 is the flowchart of processing performed by the notice transfer unit 195 in the example of a modification to the second embodiment. The processing performed by the notice transfer unit 195 is started by a processing operation 1400. In a processing operation 1401, the notice transfer unit 195 receives a notice from the outside. In a processing operation 1402, the notice transfer unit 195 determines the type of the notice. In a case where the received notice is the notice of the redistribution number transmitted from the redistribution processing unit 190, the processing proceeds to a processing operation 1403. In addition, in a case where the received notice is a sub-picture creation processing termination notice transmitted from the sub-picture creation termination notification unit 125, the processing proceeds to a processing operation 1404. In the processing operation 1403, the redistribution number holding unit 196 holds the redistribution number given notice of, and the processing returns to the processing operation 1401. In the processing operation 1404, the termination notice counting unit 197 counts the number of received sub-picture creation processing termination notices with respect to each application. In a processing operation 1405, the transfer unit 198 determines whether or not the number held in the redistribution number holding unit 196 and the number counted by the termination notice counting unit 197 coincide with each other. In a case where it is determined that the number held in the redistribution number holding unit 196 and the number of sub-picture creation termination notices do not coincide with each other, the processing returns to the processing operation 1401. In addition, in a case where the number held in the redistribution number holding unit 196 and the number of sub-picture creation termination notices coincide with each other, the processing proceeds to a processing operation 1406. In the processing operation 1406, the transfer unit 198 transfers a sub-picture creation processing termination notice to the completion detection unit 140 with respect to each application, and the processing is terminated in a processing operation 1407.

From this, even in a case where one application performs a plurality of sub-picture creation processing operations, it is possible to transmit a single sub-picture creation processing termination notice to the completion detection unit 140 when each application terminates all the sub-picture creation processing operations, and using the completion detection unit 140, it is possible to detect that all processing operations in the graphics data processing unit 200 are terminated.

Next, a third embodiment will be disclosed. In the first or second embodiment, an example of an operation in which the operation mode of the graphics data processing unit 200 is changed and power consumption is suppressed in a case where processing relating to the picture creation and the sub-picture creation based on the graphics data processing unit 200 including the GPU 210 is completed is described. In the third embodiment, an example of an operation in which the graphics data processing unit is used for a purpose other than the picture creation and the sub-picture creation processing in a case where processing relating to the sub-picture creation based on the graphics data processing unit 200 is completed will be disclosed.

In general, a GPU usable for a purpose other than the picture creation and the sub-picture creation is called a general purpose GPU (hereinafter, GPGPU). In the GPGPU, a time period within which processing relating to the picture creation or the sub-picture creation is not performed is used for another purpose. The technology illustrated in the first or second embodiment and used for completion detection may be used in a case where the GPU is used as the GPGPU. Hereinafter, as an example of processing for another purpose, processing based on a recording application X for digital television broadcasting will be described.

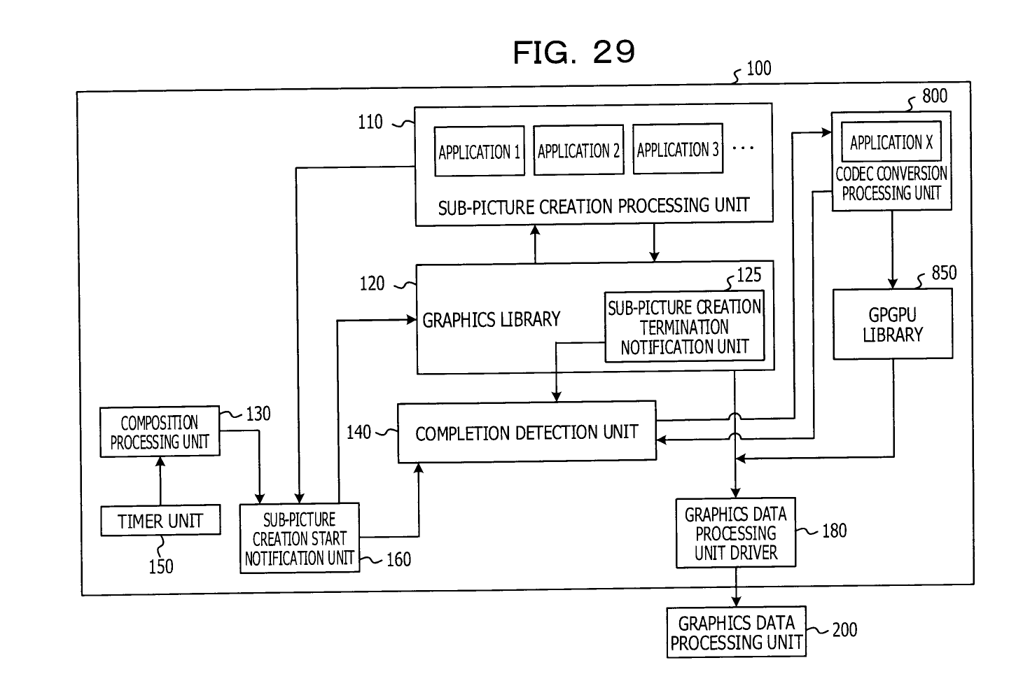

FIG. 29 is the functional block diagram of the CPU 100 in the third embodiment. A same reference symbol is assigned to the same functional block as the functional block disclosed in the first embodiment, and the description thereof will be omitted. The CPU 100 functions as a codec conversion processing unit 800 based on the application X realized by the application layer, and a GPGPU library 850 realized by the library layer, in addition to the functions illustrated in the first embodiment. The codec conversion processing unit 800 transmits a desirable instruction and desirable data to the graphics data processing unit 200, through the GPGPU library 850 and the graphics data processing unit driver 180, and performs codec conversion processing. In addition, in a case where the codec conversion processing unit 800 itself intends to use the graphics data processing unit 200, the codec conversion processing unit 800 registers a usage application for the graphics data processing unit 200, in the completion detection unit 140. In addition, upon receiving the notice of usage permission for the graphics data processing unit 200 from the completion detection unit 140, the codec conversion processing unit 800 executes codec conversion processing using the graphics data processing unit 200.

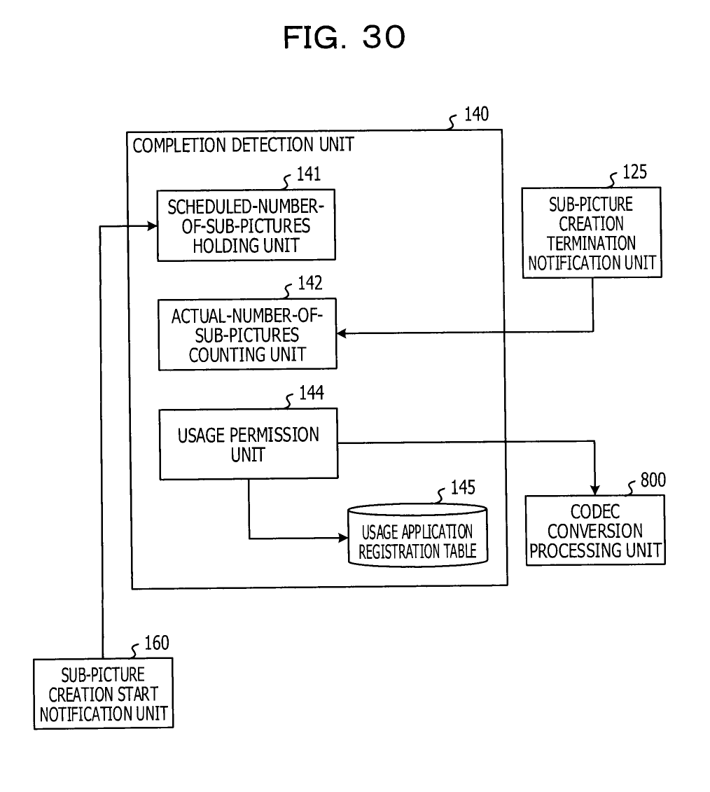

FIG. 30 is the functional block diagram of the completion detection unit 140 in the third embodiment. A same reference symbol is assigned to the same functional block as the functional block illustrated in the first embodiment, and the description thereof will be omitted. The completion detection unit 140 includes a usage permission unit 144 in addition to the scheduled-number-of-sub-pictures holding unit 141 and the actual-number-of-sub-pictures counting unit 142. In addition, the completion detection unit 140 holds a usage application registration table 145. Upon receiving a usage application from the codec conversion processing unit 800, the usage permission unit 144 registers the usage application in the usage application registration table 145. In addition, if the number held in the scheduled-number-of-sub-pictures holding unit 141 and the number of counts of the actual-number-of-sub-pictures counting unit coincide with each other, the usage permission unit 144 transmits a usage permission notice to the codec conversion processing unit 800.

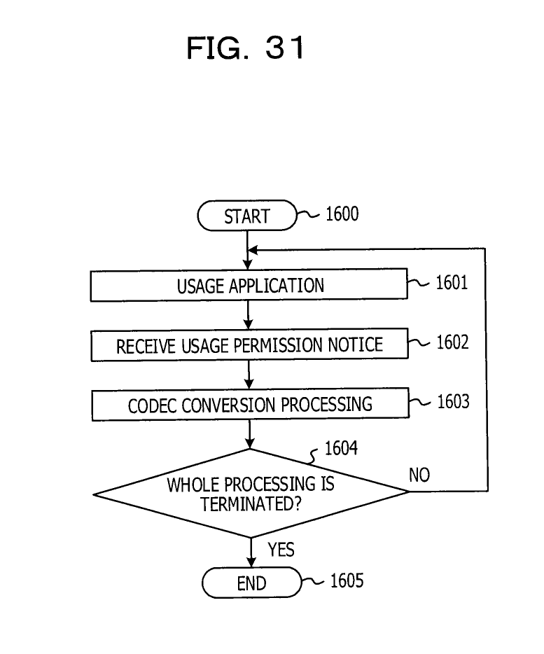

FIG. 31 is the flowchart of processing performed by the codec conversion processing unit 800. The processing performed by the codec conversion processing unit 800 is started by a processing operation 1600, and, in a processing operation 1601, the codec conversion processing unit 800 applies to the completion detection unit 140 for the usage of the graphics data processing unit 200. In a processing operation 1602, the codec conversion processing unit 800 receives a usage permission notice from the completion detection unit 140. In a processing operation 1603, the codec conversion processing unit 800 performs codec conversion processing using the graphics data processing unit 200. In a processing operation 1604, the codec conversion processing unit 800 determines whether or not whole processing performed by the codec conversion processing unit 800 itself is terminated. In a case where the whole processing is terminated, the processing is terminated in a processing operation 1605. In addition, in a case where the whole processing is not terminated, the processing returns to the processing operation 1601.

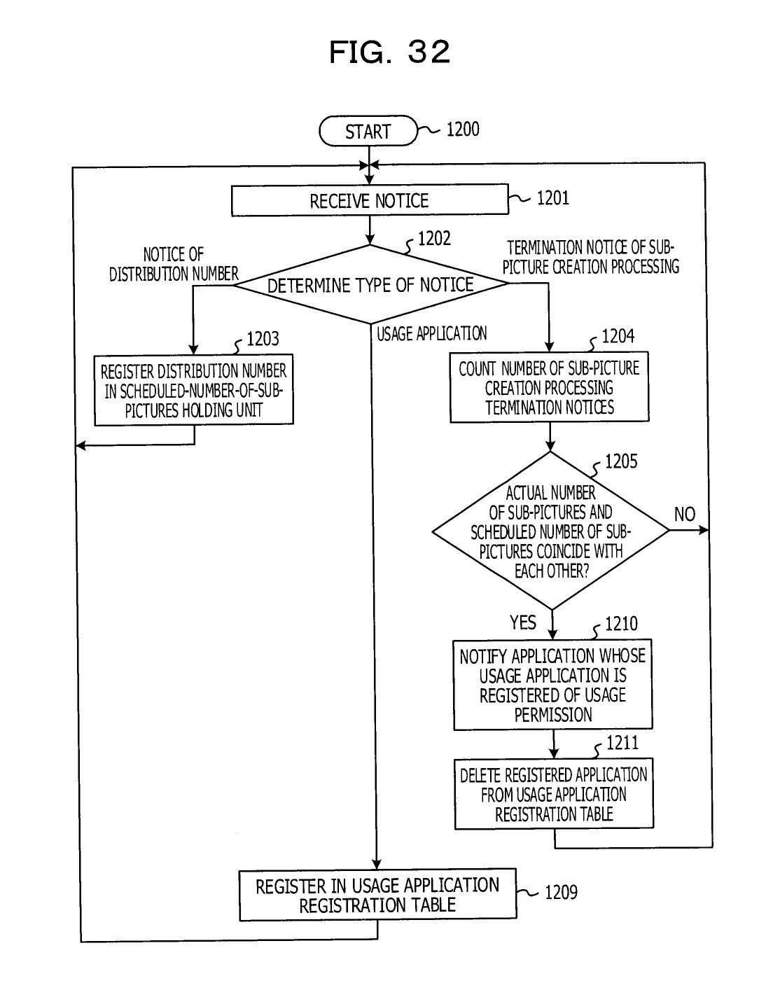

FIG. 32 is the flowchart of processing performed by the completion detection unit 140 in the third embodiment. A same reference symbol is assigned to the same processing operation as the processing operation in the first embodiment, and the description thereof will be omitted. In a case where, in the determination of the type of a notice, performed in the processing operation 1202, it is determined that a notice is a usage application from the codec conversion processing unit 800, the usage permission unit 144 registers the relevant application in the usage application registration table 145, in a processing operation 1209, and the processing returns to the processing operation 1201. In addition, in a case where, in the processing operation 1205, the actual number of sub-pictures and the scheduled number of sub-pictures coincide with each other, the processing proceeds to a processing operation 1210. In the processing operation 1210, the usage permission unit 144 notifies an application registered in the usage application registration table 145 of usage permission. In a processing operation 1211, the usage permission unit 144 deletes the registered application notified of the usage permission from the usage application registration table 145, and the processing returns to the processing operation 1201.

In this way, when another application intending to use the graphics data processing unit 200 performs a usage application and it is detected that whole processing relating to sub-picture creation in the graphics data processing unit 200 is terminated, the other application that performs the usage application is notified of usage permission. Based on such processing, it is possible to use the GPU 210 in the graphics data processing unit 200, as the GPGPU.

Note that while, in the technology disclosed this far, a description is provided on the assumption that an application performs the sub-picture creation, software that performs the sub-picture creation is not limited to an application, and the disclosed technology may be applied to a case where, for example, an operating system (OS) performs the sub-picture creation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing method for updating a picture to be displayed in a display, based on a synchronization signal issued in each predetermined time period, the data processing method comprising:
calculating a scheduled number of sub-pictures scheduled to be created by a processor in a first time period from issuing of a first synchronization signal until the predetermined time period elapses, the sub-pictures being pieces of pictures included in the picture to be displayed in the display;
counting an actual number of sub-pictures created by the processor in the first time period;
detecting that the actual number of sub-pictures reaches the scheduled number of sub-pictures; and
reducing power consumption of the processor, based on the detecting that the actual number of sub-pictures reaches the scheduled number of sub-pictures.

2. The method according to claim 1, wherein the sub-picture is a piece of picture data created by the processor executing a computer program, and the data processing method further comprising:
creating the picture to be displayed in the display, based on the sub-picture created by the processor.

3. The method according to claim 2, wherein
the creating the picture is executed based on a second synchronization signal issued subsequent to the first synchronization signal.

4. The method according to claim 3, wherein
the creating the picture is executed by the processor, and
the creating the picture is terminated prior to processing used for creating another sub-picture and executed in a second time period from issuing of the second synchronization signal until the predetermined time period elapses.

5. The method according to claim 2, further comprising:
holding, by the processor, the number of creation notices as the scheduled number of sub-pictures before issuing of the first synchronization signal, the creation notices being notices indicating that the sub-picture is created in the first time period.

6. The method according to claim 2, wherein
the processor counts the actual number of sub-pictures by detecting that the creating the sub-picture is terminated and storing of data of the created sub-picture in a memory area is terminated.

7. The method according to claim 2, wherein
the processor calculates the scheduled number of sub-pictures based on number of programs each of which creates one of the sub-pictures in the first time period.

8. The method according to claim 7, wherein
the processor counts the actual number of sub-pictures based on number of sub-pictures created by the programs in the first time period.

9. The method according to claim 2, wherein
the processor calculates and holds the scheduled number of sub-pictures, based on the number of elemental sub-pictures included in the sub-picture created in the first time period and the number of the creation notices.

10. A drawing device that updates a picture to be displayed in a display, based on a synchronization signal issued in each predetermined time period, the drawing device comprising:
a memory; and
a processor coupled to the memory and configured to
calculate a scheduled number of sub-pictures scheduled to be created by a processor in a first time period from issuing of a first synchronization signal until the predetermined time period elapses, the sub-pictures being pieces of pictures included in the picture to be displayed in the display,
count an actual number of sub-pictures created by the processor in the first time period,
detect that the actual number of sub-pictures reaches the scheduled number of sub-pictures, and
reduce power consumption of the processor, based on the detecting that the actual number of sub-pictures reaches the scheduled number of sub-pictures.

11. A non-transitory computer-readable storage medium storing a program that causes
an information processing apparatus to update a picture to be displayed in a display, based on a synchronization signal issued in each predetermined time period and to execute a process comprising:
calculating a scheduled number of sub-pictures scheduled to be created by a processor in a first time period from issuing of a first synchronization signal until the predetermined time period elapses, the sub-pictures being pieces of pictures included in the picture to be displayed in the display;
counting an actual number of sub-pictures created by the processor in the first time period;
detecting that the actual number of sub-pictures reaches the scheduled number of sub-pictures; and
reducing power consumption of the processor, based on the detecting that the actual number of sub-pictures reaches the scheduled number of sub-pictures.
